(19) United States
(12) Patent Application Publication
(10) Pub. No.: US 2023/0249189 A1
(43) Pub. Date: Aug. 10, 2023

(54) Ultra-Fast PCR Thermocycler

(71) Applicant: Fast MDx (IP) Limited, Middlesex (GB)

(72) Inventors: Ian GUNTER, Reading (GB); Richard LEWIS, London (GB)

(21) Appl. No.: 18/012,258

(22) PCT Filed: Jun. 25, 2021
(86) PCT No.: PCT/IB2021/000443

§ 371 Date: Dec. 22, 2022

Related U.S. Application Data
(60) Provisional application No. 63/119,833, filed on Dec. 1, 2020.
(60) Provisional application No. 63/044,719, filed on Jun. 26, 2020.

(51) Int. Cl. B01L 3/00; B01L 7/00

(52) U.S. Cl. CPC B01L 3/50851; B01L 7/5255; B01L 2300/12; B01L 2300/021; B01L 2300/0663; B01L 2300/0829; B01L 2300/1805

(57) ABSTRACT

Disclosed is a system with (a) a microplate comprising a metallic material for heating one or more samples during thermocycling. The microplate comprises one or more barcodes on a side of the microplate. The system may comprise a barcode reader for reading the one or more barcode. The system may also comprise a first temperature block configured to receive the microplate and/ or provide a denaturing temperature to the one or more samples contained in the microplate, during the thermocycling. The system may also comprise a second temperature block configured to receive the microplate and/or provide an extension temperature to the one or more samples contained in the microplate, during the thermocycling. The system may also comprise a conveyor configured to move the microplate between a sensing device, the first temperature block, and the second temperature block, during the thermocycling.

### CROSS-REFERENCE

This application is related to U.S. Provisional Pat. Application No. 63/044,719, filed on Jun. 26, 2020, and U.S. Provisional Pat. Application No. 63/119,833, filed on Dec. 1, 2020, both of which are incorporated herein by reference in their entirety.

### BACKGROUND

When Polymerase Chain Reaction (PCR) was discovered in 1983, researchers moved tubes containing reagents backwards and forwards between controlled temperature water baths. Eventually, companies produced machines that held the samples in a plastic plate sitting in a heat exchanger that thermally cycled the samples by using Peltier effect devices to both heat and cool the heat exchanger. Peltier effect devices can be power limited, and slow to change the temperature of the heat exchanger, especially when cooling, as heat must be extracted from the system. It can be difficult to rapidly perform successive cycles of alternate heating and cooling needed for PCR.

### SUMMARY

There is a need for a compact system for performing a polymerase chain reaction (PCR) with two or more temperatures rapidly without working at the limits of machine performance.

In an aspect, a system is disclosed. The system comprises (a) a microplate for containing one or more samples during thermocycling. The microplate comprises a first side and a second side. The first side comprises a metallic material. The microplate comprises one or more barcodes disposed on the first side or the second side. The system also comprises (b) a barcode reader for reading the one or more barcodes. The system also comprises (c) a first temperature block configured to receive the microplate and/or provide a denaturing temperature to the one or more samples contained in the microplate, during the thermocycling. The system also comprises (d) a second temperature block configured to receive the microplate and/or provide an extension temperature to the one or more samples contained in the microplate, during the thermocycling. The system also comprises (e) a conveyor configured to move the microplate between a sensing device, the first temperature block, and the second temperature block, during the thermocycling.

In some embodiments, the system is operational to complete about 20 to 80 cycles of the thermocycling in at most about 10, 11, 12, 13, 14, 15, 16, 17, 18, 19 or 20 minutes.

In some embodiments, during the thermocycling, the system is operational to transfer the one or more samples between the first temperature block and the second temperature block from about 10 to about 60 times per reaction.

In some embodiments, the microplate comprises about 48, about 96, about 384 or about 1536 individual samples.

In some embodiments, the first side of the microplate comprises an array of wells.

In some embodiments, the array conforms to a 2:3 ratio of wells along a length of the array to wells along an adjacent length of the array.

In some embodiments, the system further comprises one or more additional temperature blocks.

In some embodiments, the system comprises a heatable lid, further wherein the system is configured to provide a force of about 10 to 300 Newtons to press the heatable lid against the microplate during thermocycling.

In some embodiments, the metallic material is aluminum.

In some embodiments, the metallic material is coated with polypropylene.

In some embodiments, the denaturing temperature and/or the extension temperature is not achieved using direct resistive heating.

In some embodiments, the system further comprises a liquid handling or autopipette platform.

In some embodiments, the conveyor comprises a robotic arm.

In some embodiments, the sensing device is positioned between the first temperature block and the second temperature block, or above the first temperature block or the second temperature block, and determines a fluorescence response from the one or more samples.

In some embodiments, the one or more barcodes are disposed on the first side.

In some embodiments, the one or more barcodes are disposed on the second side.

In some embodiments, one or more samples comprise nucleic acid samples.

In some embodiments, the one or more samples comprise deoxyribonucleic acid (DNA) samples.

In some embodiments, the fluorescence response comprises ultra-rapid fluorimetry measurements.

In some embodiments, the microplate comprises alignment features for locating of the microplate for cycling the heating of the one or more samples.

In some embodiments, the first temperature block provides the denaturing temperature for about 1 to 10 seconds and the second temperature block provides the extension temperature for about 1 to 30 seconds.

In some embodiments, the denaturing temperature is between about 90° C. and 100° C.

In some embodiments, the extension temperature is between about 50° C. and 65° C.

In some embodiments, a transit time between the first temperature block and the second temperature block is between one and five seconds.

In some embodiments, the fluorescence response is recorded on a transition between the second temperature block and the first temperature block.

In some embodiments, the sensing device includes one or more light-emitting diodes (LEDs) configured to measure the fluorescence response.

In some embodiments, the fluorescence response is collected at a common temperature between about 50° C. and 65° C.

In some embodiments, the microplate is supported by a carriage.

In some embodiments, the conveyor comprises rails.

In some embodiments, the microplate is driven by a mechanical actuator.

In an aspect, a system is disclosed. The system comprises (a) a microplate for containing one or more samples during thermocycling. The microplate comprises a first side and a second side. The first side comprises a metallic material. The microplate comprises one or more barcodes disposed on the first side or the second side. The system also comprises (b) a first temperature block configured to receive the microplate and/or provide a denaturing temperature to the one or more samples contained in the microplate, during the thermocycling. The system also comprises (c) a second temperature block configured to receive the microplate and/or provide an extension temperature to the one or more samples contained in the microplate, during the thermocycling. The system also comprises (d) a sensing device positioned between the first temperature block and the second temperature block configured to determine a fluorescence response from the one or more samples. The system also comprises (e) a conveyor configured to move the microplate between the first temperature block, the sensing device, and the second temperature block, so that the sensing device determines the fluorescence response from the one or more samples when the microplate moves between the second temperature block and the first temperature block, during the thermocycling.

In some embodiments, about 20 to 80 cycles of the providing the denaturing temperature and the providing the extension temperature are completed in at most about 10, 11, 12, 13, 14, 15, 16, 17, 18, 19, or 20 minutes.

In some embodiments, during the thermocycling, the system is operational to transfer the one or more samples between the first temperature block and the second temperature block from about 10 to about 60 times per reaction.

In some embodiments, the microplate comprises about 48, about 96, about 384 or about 1536 individual samples.

In some embodiments, the first side of the microplate comprises an array of wells.

In some embodiments, the array conforms to a 2:3 ratio of wells along a length of the array to wells along an adjacent length of the array.

In some embodiments, the system further comprises one or more additional temperature blocks.

In some embodiments, the system comprises a heatable lid. The system is configured to provide a force of about 10 to 300 Newtons to press the heatable lid against the microplate during thermocycling.

In some embodiments, the metallic material is aluminum.

In some embodiments, the metallic material is coated with polypropylene.

In some embodiments, the denaturing temperature or the extension temperature is not performed using direct resistive heating.

In some embodiments, the system further comprises a liquid handling or autopipette platform.

In some embodiments, the conveyor comprises a robotic arm.

In some embodiments, the sensing device is positioned between the first temperature block and the second temperature block, or above the first temperature block or the second temperature block, and determines a fluorescence response from the one or more samples.

In some embodiments, the one or more barcodes are disposed on the first side.

In some embodiments, the one or more barcodes are disposed on the second side.

In some embodiments, one or more samples comprise nucleic acid samples.

In some embodiments, the one or more samples comprise deoxyribonucleic acid (DNA) samples.

In some embodiments, the fluorescence response comprises ultra-rapid fluorimetry measurements.

In some embodiments, the microplate comprises alignment features for locating of the microplate for cycling the heating of the one or more samples.

In some embodiments, the first temperature block provides the denaturing temperature for about 1 to 10 seconds and the second temperature block provides the extension temperature for about 1 to 30 seconds.

In some embodiments, the denaturing temperature is between about 90° C. and 100° C.

In some embodiments, the extension temperature is between about 50° C. and 65° C.

In some embodiments, a transit time between the first temperature block and the second temperature block is between one and five seconds.

In some embodiments, the fluorescence response is recorded on a transition between the second temperature block and the first temperature block.

In some embodiments, the sensing device includes one or more light-emitting diodes (LEDs) configured to measure the fluorescence response.

In some embodiments, the fluorescence response is collected at a common temperature between 50° C. and 65° C.

In some embodiments, the microplate is supported by a carriage.

In some embodiments, the conveyor comprises rails.

In some embodiments, the microplate is driven by a mechanical actuator.

In an aspect, a method for heating one or more samples during thermocycling is disclosed. The method comprises (a) identifying the one or more samples. The method also comprises (b) providing a denaturing temperature to the one or more samples at a first temperature zone during the thermocycling. The method also comprises (c) providing an extension temperature to the one or more samples at a second temperature zone during the thermocycling. The method also comprises (d) moving the microplate between the first temperature zone and the second temperature zone.

In some embodiments, about 20 to 80 cycles of the providing the denaturing temperature and the providing the extension temperature are completed in at most about 10, 11, 12, 13, 14, 15, 16, 17, 18, 19, or 20 minutes.

In some embodiments, during the thermocycling, the system is operational to transfer the one or more samples between the first temperature zone and the second temperature zone from about 10 to about 60 times per reaction.

In some embodiments, the one or more samples comprise about 48, about 96, about 384 or about 1536 individual samples.

In some embodiments, the one or more samples comprise an array of samples.

In some embodiments, the array of samples conforms to a 2:3 ratio of samples along a length of the array to samples along an adjacent length of the array.

In some embodiments, the method further comprises moving the one or more samples to additional temperature zones.

In some embodiments, providing the extension temperature or the denaturing temperature to the one or more samples comprises exerting a force of about 10 to 300 Newtons of upward force on the one or more samples.

In some embodiments, the method further comprises determining a fluorescence response from the one or more samples when they are between the first temperature zone and the second temperature zone.

In some embodiments, the fluorescence response comprises ultra-rapid fluorimetry measurements.

The method of any of claims 61 to 70, further including aligning the one or more samples prior to (b) and (c).

In some embodiments, the denaturing temperature is provided for about 1 to 2 seconds and the extension temperature is provided for about 4 to 10 seconds.

In some embodiments, the denaturing temperature is between about 92° C. and 97° C. and the extension temperature is between about 52° C. and 57° C.

In some embodiments, a transit time between the first temperature zone and the second temperature zone is about 1 to 2 seconds.

In some embodiments, the fluorescence response is recorded on a transition between the second temperature zone and the first temperature zone.

In some embodiments, the fluorescence response is collected at a temperature between about 50° C. and 65° C.

In some embodiments, the method further comprises exerting a downward force on the one or more samples.

In some embodiments, determining a fluorescence response comprises illuminating the one or more samples with a controlled wavelength of light.

In some embodiments, providing the denaturing temperature and/or the extension temperature to the one or more samples comprises thermal conduction via contact.

In some embodiments, providing the extension temperature and/or the denaturing temperature comprises transferring heat to the samples.

In some embodiments, providing the extension temperature and/or the denaturing temperature comprises transferring heat from the samples.

In some embodiments, the sensing device is a camera.

In some embodiments, the method further comprises (g) a glass lid disposed over the one or more samples.

In some embodiments, the glass lid has a coating comprising indium tin oxide (ITO).

In some embodiments, the camera is further configured to detect the fluorescence response by simultaneously capturing images of all of the one or more samples.

In an aspect, a method for heating one or more samples during thermocycling. The method comprises (a) providing a denaturing temperature to the one or more samples at a first temperature zone during the thermocycling. The method also comprises (b) providing an extension temperature to the one or more samples at a second temperature zone during the thermocycling. The method also comprises (c) while repeatedly moving the one or more samples between the second temperature zone, determining a fluorescence response from the one or more samples when they are between the second temperature zone and the first temperature zone.

In some embodiments, about 20 to 80 cycles of the providing the denaturing temperature and the providing the extension temperature are completed in not more than about 10 to 20 minutes.

In some embodiments, the one or more samples are transferred between the first temperature zone and the second temperature zone between about 10 and 60 times.

In some embodiments, the one or more samples comprise about 48, about 96, about 384 or about 1536 individual samples.

In some embodiments, the one or more samples comprise an array of samples.

In some embodiments, the array of samples conforms to a 2:3 ratio of samples along a length of the array to samples along an adjacent length of the array.

In some embodiments, the method further comprises moving the one or more samples between additional temperature zones.

In some embodiments, providing the extension temperature or the denaturing temperature to the one or more samples includes exerting a force of about 10 to 300 newtons of upward force to the samples.

In some embodiments, the fluorescence response comprises ultra-rapid fluorimetry measurements.

In some embodiments, the method further comprises aligning the one or more samples prior to (b) and (c).

In some embodiments, the denaturing temperature is provided for about 1 to 2 seconds and the extension temperature is provided for about 4 to 10 seconds.

In some embodiments, the denaturing temperature is between 92° C. and 97° C. and the extension temperature is between about 52° C. and 57° C.

In some embodiments, a transit time between the first temperature zone and the second temperature zone is about one to five seconds.

In some embodiments, the fluorescence response is recorded on a transition between the second temperature zone and the first temperature zone.

In some embodiments, the fluorescence response is collected at a temperature between about 50° C. and 65° C.

In some embodiments, the method further comprises exerting a downward force on the one or more samples.

In some embodiments, determining the fluorescence response comprises illuminating the one or more samples with a controlled wavelength of light.

In some embodiments, providing the denaturing temperature and/or the extension temperature to the one or more samples comprises thermal conduction via contact.

In some embodiments, providing the extension temperature and/or the denaturing temperature comprises transferring heat to the samples.

In some embodiments, providing the extension temperature and/or the denaturing temperature comprises transferring heat from the samples.

In an aspect, a system is disclosed. The system comprises (a) a microplate for containing one or more samples during thermocycling. The microplate comprises a first side and a second side. The first side comprises a metallic material. The microplate comprises one or more barcodes disposed on the first side or the second side. The system also comprises (b) a barcode reader for reading the one or more barcodes. The system also comprises (c) a first temperature block configured to receive the microplate and provide a denaturing temperature to the one or more samples contained in the microplate, during the thermocycling. The system also comprises (d) a second temperature block configured to receive the microplate and provide an extension temperature to the one or more samples contained in the microplate, during the thermocycling. The system also comprises (e) a conveyor configured to move the microplate between a sensing device, the first temperature block, and the second temperature block, during the thermocycling.

In some embodiments, the system is operational to complete about 20 to 80 cycles of the thermocycling in at most about 10, 11, 12, 13, 14, 15, 16, 17, 18, 19 or 20 minutes.

In some embodiments, during the thermocycling, the system is operational to transfer the one or more samples between the first temperature block and the second temperature block from about 10 to about 60 times per reaction.

In some embodiments, the microplate comprises about 48, about 96, about 384 or about 1536 individual samples.

In some embodiments, the first side of the microplate comprises an array of wells.

In some embodiments, the array conforms to a 2:3 ratio of wells along a length of the array to wells along an adjacent length of the array.

In some embodiments, the system further comprises further comprising one or more additional temperature blocks.

In some embodiments, the system comprises a heatable lid, further wherein the system is configured to provide a force of about 10 to 300 Newtons to press the heatable lid against the microplate during thermocycling.

In some embodiments, the metallic material is aluminum.

In some embodiments, the metallic material is coated with polypropylene.

In some embodiments, the denaturing temperature and/or the extension temperature is not achieved using direct resistive heating.

In some embodiments, the system further comprises further comprising a liquid handling or autopipette platform.

In some embodiments, the conveyor comprises a robotic arm.

In some embodiments, the sensing device is positioned between the first temperature block and the second temperature block, or above the first temperature block or the second temperature block, and determines a fluorescence response from the one or more samples.

In some embodiments, the one or more barcodes are disposed on the first side.

In some embodiments, the one or more barcodes are disposed on the second side.

In some embodiments, one or more samples comprise nucleic acid samples.

In some embodiments, the one or more samples comprise deoxyribonucleic acid (DNA) samples.

In some embodiments, the fluorescence response comprises ultra-rapid fluorimetry measurements.

In some embodiments, the microplate comprises alignment features for locating of the microplate for cycling the heating of the one or more samples.

In some embodiments, the first temperature block provides the denaturing temperature for about 1 to 10 seconds and the second temperature block provides the extension temperature for about 1 to 30 seconds.

In some embodiments, the denaturing temperature is between about 90° C. and 100° C.

In some embodiments, the extension temperature is between about 50° C. and 65° C.

In some embodiments, a transit time between the first temperature block and the second temperature block is between one and five seconds.

In some embodiments, the fluorescence response is recorded on a transition between the second temperature block and the first temperature block.

In some embodiments, the sensing device includes one or more light-emitting diodes (LEDs) configured to measure the fluorescence response.

In some embodiments, the fluorescence response is collected at a common temperature between about 50° C. and 65° C.

In some embodiments, the microplate is supported by a carriage.

In some embodiments, the conveyor comprises rails.

In some embodiments, the microplate is driven by a mechanical actuator.

In one aspect, a system is disclosed. The system comprises (a) a microplate for containing one or more samples during thermocycling. The microplate comprises a first side and a second side. The first side comprises a metallic material. The microplate comprises one or more barcodes disposed on the first side or the second side. The system comprises (b) a first temperature block configured to receive the microplate and provide a denaturing temperature to the one or more samples contained in the microplate, during the thermocycling. The system comprises (c) a second temperature block configured to receive the microplate and provide an extension temperature to the one or more samples contained in the microplate, during the thermocycling. The system also comprises (d) a sensing device positioned between the first temperature block and the second temperature block configured to determine a fluorescence response from the one or more samples. The system also comprises (e) a conveyor configured to move the microplate between the first temperature block, the sensing device, and the second temperature block, so that the sensing device determines the fluorescence response from the one or more samples when the microplate moves between the second temperature block and the first temperature block, during the thermocycling.

In some embodiments, the system is operational to complete about 20 to 80 cycles of the thermocycling in at most about 10, 11, 12, 13, 14, 15, 16, 17, 18, 19 or 20 minutes.

In some embodiments, during the thermocycling, the system is operational to transfer the one or more samples between the first temperature block and the second temperature block from about 10 to about 60 times per reaction.

In some embodiments, the microplate comprises about 48, about 96, about 384 or about 1536 individual samples.

In some embodiments, the first side of the microplate comprises an array of wells.

In some embodiments, the array conforms to a 2:3 ratio of wells along a length of the array to wells along an adjacent length of the array.

In some embodiments, the system further comprises further comprising one or more additional temperature blocks.

In some embodiments, the system comprises a heatable lid, further wherein the system is configured to provide a force of about 10 to 300 Newtons to press the heatable lid against the microplate during thermocycling.

In some embodiments, the metallic material is aluminum.

In some embodiments, the metallic material is coated with polypropylene.

In some embodiments, the denaturing temperature and/or the extension temperature is not achieved using direct resistive heating.

In some embodiments, the system further comprises further comprising a liquid handling or autopipette platform.

In some embodiments, the conveyor comprises a robotic arm.

In some embodiments, the one or more barcodes are disposed on the first side.

In some embodiments, the one or more barcodes are disposed on the second side.

In some embodiments, one or more samples comprise nucleic acid samples.

In some embodiments, the one or more samples comprise deoxyribonucleic acid (DNA) samples.

In some embodiments, the fluorescence response comprises ultra-rapid fluorimetry measurements.

In some embodiments, the microplate comprises alignment features for locating of the microplate for cycling the heating of the one or more samples.

In some embodiments, the first temperature block provides the denaturing temperature for about 1 to 10 seconds and the second temperature block provides the extension temperature for about 1 to 30 seconds.

In some embodiments, the denaturing temperature is between about 90° C. and 100° C.

In some embodiments, the extension temperature is between about 50° C. and 65° C.

In some embodiments, a transit time between the first temperature block and the second temperature block is between one and five seconds.

In some embodiments, the fluorescence response is recorded on a transition between the second temperature block and the first temperature block.

In some embodiments, the sensing device includes one or more light-emitting diodes (LEDs) configured to measure the fluorescence response.

In some embodiments, the fluorescence response is collected at a common temperature between about 50° C. and 65° C.

In some embodiments, the microplate is supported by a carriage.

In some embodiments, the conveyor comprises rails.

In some embodiments, the microplate is driven by a mechanical actuator.

In an aspect, a thermocycler system is disclosed. The thermocycler system comprises (a) a first temperature block configured to receive a microplate containing one or more samples and/or provide a denaturing temperature to the one or more samples contained in the received microplate, during thermocycling of the contained samples. The thermocycler system also comprises (b) a second temperature block configured to receive the microplate and/or provide an extension temperature to the one or more samples contained in the microplate, during the thermocycling. The thermocycler system also comprises (c) a barcode reader for reading one or more barcodes disposed on the microplate. The thermocycler system also comprises (d) a conveyor configured to move the microplate between a sensing device, the first temperature block, and the second temperature block, during the thermocycling.

In some embodiments, the system is operational to complete about 20 to 80 cycles of the thermocycling in at most about 10, 11, 12, 13, 14, 15, 16, 17, 18, 19 or 20 minutes.

In some embodiments, during the thermocycling, the system is operational to transfer the one or more samples between the first temperature block and the second temperature block from about 10 to about 60 times per reaction.

In some embodiments, the microplate comprises about 48, about 96, about 384 or about 1536 individual samples.

In some embodiments, the microplate comprises an array of wells.

In some embodiments, the array conforms to a 2:3 ratio of wells along a length of the array to wells along an adjacent length of the array.

In some embodiments, the system comprises a heatable lid, further wherein the system is configured to provide a force of about 10 to 300 Newtons to press the heatable lid against the microplate during thermocycling.

In some embodiments, the microplate comprises a first side, which first side comprises a metallic material, wherein the metallic material is aluminum.

In some embodiments, the metallic material is coated with polypropylene.

In some embodiments, the denaturing temperature and/or the extension temperature is not achieved using direct resistive heating.

In some embodiments, the system further comprises a liquid handling or autopipette platform.

In some embodiments, the conveyor comprises a robotic arm.

In some embodiments, the sensing device is positioned between the first temperature block and the second temperature block, or above the first temperature block or the second temperature block, and determines a fluorescence response from the one or more samples.

In some embodiments, the one or more barcodes are disposed on the first side.

In some embodiments, the one or more barcodes are disposed on the second side.

In some embodiments, one or more samples comprise nucleic acid samples.

In some embodiments, the one or more samples comprise deoxyribonucleic acid (DNA) samples.

In some embodiments, the fluorescence response comprises ultra-rapid fluorimetry measurements.

In some embodiments, the microplate comprises alignment features for locating of the microplate for cycling the heating of the one or more samples.

In some embodiments, the first temperature block provides the denaturing temperature for about 1 to 10 seconds and the second temperature block provides the extension temperature for about 1 to 30 seconds.

In some embodiments, the denaturing temperature is between about 90° C. and 100° C.

In some embodiments, the extension temperature is between about 50° C. and 65° C.

In some embodiments, a transit time between the first temperature block and the second temperature block is between one and five seconds.

In some embodiments, the fluorescence response is recorded on a transition between the second temperature block and the first temperature block.

In some embodiments, the sensing device includes one or more light-emitting diodes (LEDs) configured to measure the fluorescence response.

In some embodiments, the fluorescence response is collected at a common temperature between about 50° C. and 65° C.

In some embodiments, the microplate is supported by a carriage.

In some embodiments, the conveyor comprises rails.

In some embodiments, the microplate is driven by a mechanical actuator.

Another aspect of the present disclosure provides a non-transitory computer readable medium comprising machine-executable code that, upon execution by one or more computer processors, implements any method of the present disclosure (e.g., by directing one or more processing operations).

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 illustrates a microplate with 96 wells;

FIGS. 2A-B illustrate views of a 48-well microplate;

FIG. 3 illustrates a schematic of the ultrafast PCR thermocycler;

FIG. 4 shows a computer control system that is programmed or otherwise configured to implement methods provided herein;

FIG. 5 illustrates another schematic of the ultrafast PCR thermocycler; and

FIG. 6 illustrates a configuration of the sensing device.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

In an aspect, a system is disclosed. The system comprises (a) a microplate for containing one or more samples during thermocycling. The microplate comprises a first side and a second side. The first side comprises a metallic material. The microplate comprises one or more barcodes disposed on the first side or the second side. The system also comprises (b) a barcode reader for reading the one or more barcodes. The system also comprises (c) a first temperature block configured to receive the microplate and/or provide a denaturing temperature to the one or more samples contained in the microplate, during the thermocycling. The system also comprises (d) a second temperature block configured to receive the microplate and/or provide an extension temperature to the one or more samples contained in the microplate, during the thermocycling. The system also comprises (e) a conveyor configured to move the microplate between a sensing device, the first temperature block, and the second temperature block, during the thermocycling.

In an aspect, a system is disclosed. The system comprises (a) a microplate for containing one or more samples during thermocycling. The microplate comprises a first side and a second side. The first side comprises a metallic material. The microplate comprises one or more barcodes disposed on the first side or the second side. The system also comprises (b) a first temperature block configured to receive the microplate and/or provide a denaturing temperature to the one or more samples contained in the microplate, during the thermocycling. The system also comprises (c) a second temperature block configured to receive the microplate and/or provide an extension temperature to the one or more samples contained in the microplate, during the thermocycling. The system also comprises (d) a sensing device positioned between the first temperature block and the second temperature block configured to determine a fluorescence response from the one or more samples. The system also comprises (e) a conveyor configured to move the microplate between the first temperature block, the sensing device, and the second temperature block, so that the sensing device determines the fluorescence response from the one or more samples when the microplate moves between the second temperature block and the first temperature block, during the thermocycling.

In an aspect, a method for heating one or more samples during thermocycling is disclosed. The method comprises (a) identifying the one or more samples. The method also comprises (b) providing a denaturing temperature to the one or more samples at a first temperature zone during the thermocycling. The method also comprises (c) providing an extension temperature to the one or more samples at a second temperature zone during the thermocycling. The method also comprises (d) moving the microplate between the first temperature zone and the second temperature zone.

In an aspect, a method for heating one or more samples during thermocycling. The method comprises (a) providing a denaturing temperature to the one or more samples at a first temperature zone during the thermocycling. The method also comprises (b) providing an extension temperature to the one or more samples at a second temperature zone during the thermocycling. The method also comprises (c) while repeatedly moving the one or more samples between the second temperature zone, determining a fluorescence response from the one or more samples when they are between the second temperature zone and the first temperature zone.

In an aspect, a system is disclosed. The system comprises (a) a microplate for containing one or more samples during thermocycling. The microplate comprises a first side and a second side. The first side comprises a metallic material. The microplate comprises one or more barcodes disposed on the first side or the second side. The system also comprises (b) a barcode reader for reading the one or more barcodes. The system also comprises (c) a first temperature block configured to receive the microplate and provide a denaturing temperature to the one or more samples contained in the microplate, during the thermocycling. The system also comprises (d) a second temperature block configured to receive the microplate and provide an extension temperature to the one or more samples contained in the microplate, during the thermocycling. The system also comprises (e) a conveyor configured to move the microplate between a sensing device, the first temperature block, and the second temperature block, during the thermocycling.

In one aspect, a system is disclosed. The system comprises (a) a microplate for containing one or more samples during thermocycling. The microplate comprises a first side and a second side. The first side comprises a metallic material. The microplate comprises one or more barcodes disposed on the first side or the second side. The system comprises (b) a first temperature block configured to receive the microplate and provide a denaturing temperature to the one or more samples contained in the microplate, during the thermocycling. The system comprises (c) a second temperature block configured to receive the microplate and provide an extension temperature to the one or more samples contained in the microplate, during the thermocycling. The system also comprises (d) a sensing device positioned between the first temperature block and the second temperature block configured to determine a fluorescence response from the one or more samples. The system also comprises (e) a conveyor configured to move the microplate between the first temperature block, the sensing device, and the second temperature block, so that the sensing device determines the fluorescence response from the one or more samples when the microplate moves between the second temperature block and the first temperature block, during the thermocycling.

In an aspect, a thermocycler system is disclosed. The thermocycler system comprises (a) a first temperature block configured to receive a microplate containing one or more samples and/or provide a denaturing temperature to the one or more samples contained in the received microplate, during thermocycling of the contained samples. The thermocycler system also comprises (b) a second temperature block configured to receive the microplate and/or provide an extension temperature to the one or more samples contained in the microplate, during the thermocycling. The thermocycler system also comprises (c) a barcode reader for reading one or more barcodes disposed on the microplate. The thermocycler system also comprises (d) a conveyor configured to move the microplate between a sensing device, the first temperature block, and the second temperature block, during the thermocycling.

In one aspect, a system for providing ultra-fast thermocycling is disclosed. The thermocycling may be for polymerase chain reaction (PCR). The system may comprise a microplate for containing one or more samples during thermocycling. The microplate may comprise at least a first side and a second side. For example, the microplate may be a substantially flat plate with a top side and a bottom (reverse side). In other embodiments, the microplate may have additional sides, in addition to the top and bottom side (e.g., adjacent sides of a rectangular prism) onto which information may be recorded or mechanical features may be attached to facilitate handling and transport of the microplate through the thermocycler. The microplate may be a rigid rectangular plate made of aluminum or another metallic material with a polymeric coating on the first side (e.g., polypropylene). Disposed on the polymeric coating may be a plurality of wells (e.g., circular or square wells), rings, or tubes, also made of the same or a different polymeric material. The microplate may have rectangular dimensions which conform to a 2:3 ratio of wells in a width to wells in a length (or, a number of wells on one side of the array to a number of wells on an adjacent side of the array), and may include 6, 12, 24, 48, 96, 384, or 1536 wells, in an array of dimensions, for example, 2×3, 4×6, 8×12, 16×24, or 32×48 wells.

The microplate may comprise one or more barcodes disposed on the first side or the second side. For example, one or more barcodes may be placed on a portion of the first side of the microplate not containing the samples. One or more barcodes may be placed on a portion of the bottom of the microplate comprising at least 50% of the area of the bottom of the microplate, or at least 40% of the area of the bottom of the microplate, or at least 30% of the area of the bottom of the microplate, or at least 20% of the area of the bottom of the microplate, or at least 10% of the area of the bottom of the microplate, or at least 5% of the area of the bottom of the microplate. In embodiments where the microplate may have thicker sides perpendicular to the sample-containing side, one or more barcodes may be placed on one of these thicker sample-adjacent sides. The microplate may have one barcode identifying all of the samples contained. The microplate may have two or more barcodes describing subsets of samples, where different sections of the microplate may contain different types of samples. The microplate may have a bar code disposed underneath and on the opposite side of each sample well identifying a different sample contained in each individual well.

The system may include a barcode reader. The barcode reader may be an optical sensor that registers a barcode printed on the microplate and decodes the barcode (using a computing device) to determine the identity of the sample in the microplate. The barcode reader may be a handheld scanner, a pen-type scanner, a laser scanner, a camera, or another type of optical sensor.

The system may include two or more temperature blocks or temperature units. The temperature blocks may be configured to transfer heat to and from the samples during thermocycling. The temperature blocks may be disposed underneath the microplate such that they contact the microplate to provide heating and provide an upward force to press the microplate against a heatable lid. In addition to providing upward force necessary to press the microplate to the heatable lid, some temperature units may fully or partially enclose or encapsulate the microplate (e.g., like a sleeve) to provide heating from multiple sides. A temperature block may itself be heated by a resistive heating method, or a Peltier heating method, to maintain a constant temperature of the block. One resistive heating system for the temperature block may include using an embedded cartridge heater. A temperature block may be heated using a convection heating system. For example, the temperature block may contain channels within the block for circulating heated liquids. Another convection heating method may use an attached strip heater. Another convection heating method may use a capillary tube heater. A temperature block may be disposed underneath the microplate or otherwise configured to, when actuated via lifting cams or another mechanical apparatus, exert a force on the samples to press them against a heatable lid or another type of opposing second surface. The resultant clamping action may provide rapid, even heating or cooling to the samples.

The temperature blocks may include a first temperature block configured to receive the microplate and provide a denaturing temperature to the samples within the microplate.The temperature blocks may comprise a second temperature block configured to receive the microplate and provide an extension temperature to the samples. The second temperature block may be of the same material as the first block or may be of a different material. The first temperature block may provide the denaturing temperature for 1-10 seconds and the second temperature block may provide the extension temperature for 1-30 seconds.

The denaturing temperature is the temperature for denaturing, or “melting” of nucleic acids. At this temperature, the thermocycler breaks the hydrogen bonds between complementary nucleic acid bases, yielding two single-stranded nucleic acid molecules. The denaturing temperature may be between 90° C. and 100° C.

The extension temperature is a temperature for synthesizing a new nucleic acid strand complementary to a nucleic acid template strand, thus completing one cycle for amplifying a nucleic acid target. The extension temperature may be between 50° C. and 65° C.

Prior to extension, annealing may be performed by the second temperature block. Annealing may be performed at the extension temperature. Annealing may comprise binding of primers to nucleic acid template strands, to synthesize new nucleic acids.

The thermocycling system may also include a conveyor configured to move the microplate from the barcode reader to the temperature blocks, and then rapidly between the temperature blocks and a sensing device. The conveyor may be a moving track. The conveyor may include a set of rails, e.g., ball rails, that the microplate is mounted upon. The microplate may be moved between the thermocycler components on the rails using a mechanical actuator. The mechanical actuator may be a leadscrew or another device that may move the microplate using a screwing motion. The conveyor may be a toothed belt, mounted over pulleys of sprockets. A stepper motor may move the microplate forward by causing gears disposed underneath the toothed belt to rotate, causing the toothed belt to move. In other embodiments, the microplate may move using a rack-and-pinion system. In other embodiments, the microplate may move on a system comprising pulleys and chains.

Additionally, the microplate may be disposed on a platform not supported by a track and moved using an actuator (e.g., a pneumatic, thermal, electrical, mechanical, or hydraulic actuator). The microplate may be driven by a motor. The microplate may be held by a robotic arm and moved between the heated blocks, being controlled manually by an operator. In other embodiments, robotic control may be partially automated. In other embodiments, robotic control may be fully automated.

The microplate may transit between the temperature blocks within 1, 2, 3, 4, or 5 seconds. The microplate may transit between the blocks at different speeds (e.g., from the first block to the second block more quickly than in the reverse direction, or vice-versa). Transit speed between blocks may be about at least 100 mm/s, or about at least 150 mm/s, or about at least 200 mm/s, or about at least 250 mm/s, or about at least 300 mm/s, or about at least 350 mm/s. Transit speed between blocks may be about at most 100 mm/s, or about at most 150 mm/s, or about at most 200 mm/s, or about at most 250 mm/s, or about at most 300 mm/s, or about at most 350 mm/s. Transit speed between blocks may be between about 100 mm/s and 150 mm/s, or between about 150 mm/s and 200 mm/s, or between about 200 mm/s and 250 mm/s, or between about 250 mm/s and 300 mm/s, or between about 300 mm/s and 350 mm/s, or between about 350 mm/s and 400 mm/s.

Transmission of the microplate from the first block to the second may be about 150 mm/s and transmission of the microplate from the second block to the first block may be about 200 mm/s, or vice-versa. Transmission from the first block to the second may be about 200 mm/s and transmission from the second block to the first block may be about 250 mm/s, or vice-versa. Transmission from the first block to the second may be about 250 mm/s and transmission from the second block to the first block may be about 300 mm/s, or vice-versa. Transmission from the first block to the second may be about 100 mm/s and transmission from the second block to the first block may be about 200 mm/s, or vice-versa. Transmission from the first block to the second may be about 150 mm/s and transmission from the second block to the first block may be about 250 mm/s, or vice-versa. Transmission from the first block to the second may be about 200 mm/s and transmission from the second block to the first block may be about 300 mm/s, or vice-versa.

The sensing device may track the progress of a reaction (e.g., PCR) during thermocycling. The sensing device may be positioned between the two temperature blocks. The sensing device may be positioned directly above either of the two temperature blocks. The sensing device may be positioned in the same horizontal plane (to the side of) the two temperature blocks. The sensing device may be positioned above and at an angle to the two temperature blocks. In other embodiments with additional temperature blocks, the sensing device may be positioned to collect a fluorescence response following extension. For example, the sensing device may be positioned between first and second blocks, or between second and third blocks. The sensing device may be positioned above the first block, above the second block, or above the third block. In embodiments with additional temperature blocks, there may be additional sensing devices. For example, there may be a sensing device between the first and second blocks and between the second and third blocks.

The sensing device may provide visual indicators. The sensing device may measure luminescence emitted during the PCR reaction. The luminescence may be chemiluminescence. The sensing device may use luminescence reporters, such as lanthanide reporters.

The sensing device may measure fluorescence emitted during the PCR reaction. The samples may be contacted with a probe or dye that may cause the samples to fluoresce as the microplate enters the location of the sensing device. For example, the sensing device may be an optical scanner comprising one or more light-emitting diodes (LEDs), photodiodes, and one or more filters. The LEDs may stimulate fluorescence by contacting the samples with attached probes or dyes with light. In some embodiments, different light sources may be used to stimulate fluorescent emissions, such as ultraviolet (UV) light sources (e.g., lasers) or lamps (e.g., tungsten-halogen lamps). The filters may be bandpass filters or other filters configured to limit the emitted wavelengths to those that would stimulate fluorescent emissions. The photodiodes may detect such fluorescent emissions and convert the collected signals into electrical signals, which may reflect quantifiable fluorescence measurements. A fluorescence measurement (referred to herein interchangeably with “fluorescence response”) may be recorded on a transition between the second temperature block and the first temperature block. The sensing device may perform fluorescence measurements (or collect fluorescence responses) when the microplate moves between the second temperature block and the first temperature block (from extension to denaturing). The sensing device may perform all fluorescence measurements (or collect fluorescence responses) when the microplate is at a particular temperature in the range from 50° C. to 65° C. The sensing device may measure properties of fluorescence emitted by the samples. For example, the sensing device may measure fluorescence polarization.

The sensing device may be a camera. The camera may be configured to detect fluorescence by simultaneously capturing images of the samples in the microplate wells. The camera may be a charge coupled device (CCD), an electron multiplying CCD (EMCCD), or a scientific complimentary metal-oxide semiconductor (sCMOS) device. The camera may comprise an array of pixels, a pixel comprising a photodiode with a silicon substrate coupled to an electron storage well. When the photons hit the silicon substrate, photoelectrons are generated. These photoelectrons are converted into a voltage by an amplifier, which in turn may be converted into a digital signal by an analog-digital converter (ADC).

The fluorescence response may comprise one or more ultra-rapid fluorimetry measurements. The sensing device may use a light source, such as a light-emitting diode (LED), to excite fluorescence in the samples. Photodiodes may measure the fluorescence response. In other embodiments, the sensing device may use another light source. For example, the sensing device may use a laser. The sensing device may use a filtered incandescent light source. The sensing device may use a lamp. The lamp may be a tungsten-halogen lamp. For example, a laser fluorimetry method may capture a fluorescence response. In some embodiments, a spectrofluorometer may capture a fluorescence response.

The microplate may include alignment features for precisely locating or placing the microplate within the thermocycler system for heating, barcode scanning, and/or sensing. For example, the microplate may include a plurality of notches for enabling the microplate to adhere to, fit, or otherwise interface with a guiding system. In some embodiments, the guiding system may comprise one or more tracks. In some embodiments, the guiding system may comprise one or more rails. In some embodiments, the guiding system may comprise one or more poles. The microplate, if rectangular, may include a matching number of notches along its perimeter, a larger number of notches on the long section of its perimeter, or a larger number of notches on the small section of its perimeter. The microplate may include, for example, 2, 4, 6, 8, 10,12, 14, 16, 18, 20, or more notches total. The microplate may have about 1, 2, 3, 4, 5, 6, 7, 8, or more, notches on the long section of its perimeter. The microplate may have about 1, 2, 3, 4, 5, 6, or more notches on the short side of its perimeter. The notches may be rectangular, circular, ovular, or triangular in shape.

During thermocycling, the microplate may be moved between the second temperature block and the first temperature block between 10 and 60 times. Cycling in this fashion may be completed in less than about 10 minutes, or less than about 25 minutes. For example, 20-80 cycles may be completed in 10-20 minutes.

The microplate may be usable with various types of liquid handling equipment used in laboratories. The liquid handling equipment may include centrifuges. Liquid handling may comprise removing contents of a microplate well for further analysis using laboratory equipment. For example, liquid handling may comprise piercing. The liquid handling equipment may include piercers. Liquid handling may comprise aspirating fluid. The liquid handling equipment may include aspirators. Liquid handling equipment may include vacuum pumps.

Liquid handling equipment may include equipment for dispensing liquids or other media. The liquid handling equipment may be a pipette or pipetting system. The pipetting system may be an autopipette platform.

In some embodiments, one or more methods disclosed herein can be completely automated. In some embodiments, one or more steps disclosed herein can be automated. .In some embodiments, a portion of any method disclosed herein may be automated. In some embodiments, another portion of any method disclosed herein may not be automated.

The microplate size, shape, and array format in which microplate wells are disposed may enable it to be used for post-test procedures using standard equipment. Post-test procedures may include sample analysis procedures. Sample analysis may be gel electrophoresis. Sample analysis may be mass spectrometry.

In some cases, the system may have one or more additional temperature blocks. For example, the system may have a third temperature block, with one block providing an extension temperature, one block providing an annealing temperature, and one block providing a denaturing temperature. Such an embodiment may have additional sensing devices for providing fluorescence measurements when the microplate shifts between any pair of blocks.

Providing the extension temperature or the denaturing temperature to the samples may comprise exerting a force, by applying pressure on the samples from a temperature block, of ten to 300 newtons. Lifting cams disposed underneath the temperature blocks may push the temperature blocks upward. Such a force may press the microplate containing the samples to a heatable lid, and the pressure from both the lid and the temperature block may quicken the pace of heat transfer from the temperature block to the samples within the microplate. For example, such a process may quicken heating or cooling of the samples. Additionally, the pressure exerted by the microplate may provide even heating or cooling to the samples.

The heatable lid may be held in place by a mechanical system. For example, the heatable lid may be held in place using cabling. The heatable lid may be held in place using pulleys. The heatable lid may be held in place using a mechanical actuator. The heatable lid may be held in place using a robotic arm. The heatable lid may be held in place using an adhesive system. For example, the heatable lid may be welded to a suspended flat surface. The heatable lid may be fitted to an enclosure. The heatable lid may be placed on a set of rails and be fitted to the rails using alignment notches similar to those for aligning the microplate with the heating blocks.

The sample wells in the microplate may be automatically sealed. A machine or computer-controlled device may be configured to locate the microplate wells and apply seals to each of the wells. The sample wells may also be sealed manually or via manual control of a device. The seal may be a heat sealing film. The film may be a transparent film. The film may be a translucent film. The film may be an opaque film. A plurality of the microplate wells may be sealed with a transparent film, while the remaining wells may be sealed with a translucent film. A plurality of the microplate wells may be sealed with a transparent film, while the remaining wells may be sealed with an opaque film. A plurality of the microplate wells may be sealed with an opaque film, while the remaining wells may be sealed with a translucent film. An individual film may be partially transparent and partially translucent. An individual film may be partially translucent and partially opaque. An individual film may be partially opaque and partially transparent. The sample wells may be covered with a glass lid. The glass lid may be coated with a transparent conducting oxide. For example, the glass lid may have an indium tin oxide (ITO), coating, to enable it to be electrically heated. The glass lid may be coated with aluminum-doped zinc oxide (AZO). The glass lid may be coated with indium-doped cadmium oxide. The glass lid may be coated with barium stannate. The glass lid may be coated with strontium vanadate. The glass lid may be coated with calcium vanadate.

The samples in the microplate may be nucleic acid samples. For example, the samples may be deoxyribonucleic acid (DNA) samples. The samples may be from a human subject (e.g., from particular cells or tissue), a plant, animal, bacterium, virus, or other organism.

In another aspect, a method for fast PCR thermocycling of one or more samples is described. The method may first include identifying the one or more samples. The samples may be placed in a microplate, with at least one side containing a bar code. A bar code scanner may scan the bar code and determine the identity of the samples. Then, the heating process may include providing a denaturing temperature to the one or more samples at a first temperature zone, during the thermocycling. The first temperature zone may be a location where forces are exerted on the samples (e.g., upward pressure and downward pressure) as heating is applied from two directions (upward and downward). The heating elements providing the heating and forces may be a heatable lid and a temperature block. The heating process may also include providing an extension temperature to the one or more samples at a second temperature zone, during the thermocycling. The extension temperature may additionally be provided using upward and downward forces and heating. An upward force may be exerted by a lifting apparatus (e.g., lifting cams) to push the temperature block upwards. A heatable lid may provide a downward force as the microplate is pressed up against it by the temperature block. The heating process may include moving the samples between the first temperature zone and the second temperature zone. Movement may be performed using a screwing motion, a motion provided by a robotic arm, an actuation method, by placement on a moving track or apparatus, or by a mechanical handling method. The heating process may include, while the samples are moving from the second temperature zone to the first temperature zone, determining a fluorescence response from the one or more samples.

The heating process may move the samples between more than two temperature zones. For example, the heating process may move the samples to one or more additional temperature zones, in addition to those for extension and denaturing. For example, one additional temperature zone may be for denaturing. Another additional temperature zone may be for reverse transcription. In some embodiments, moving to the temperature zone for reverse transcription may comprise heating the samples between about 25° C. and 58° C. In some embodiments, moving to the temperature zone for reverse transcription may comprise heating the samples between about 42° C. and 48° C. In some embodiments, the reverse transcription time may be less than about 10 minutes, less than about 20 minutes, less than about 30 minutes, or less than about 40 minutes. In some embodiments, the reverse transcription time may be more than about 10 minutes, more than about 20 minutes, less more about 30 minutes, or more than about 40 minutes. In some embodiments, the reverse transcription time may be between about one and ten minutes, between about 10 and 20 minutes, between about 20 and 30 minutes, or between about 30 and 40 minutes.

### Microplates for Polymerase Chain Reaction (PCR)

In some embodiments, microplate assemblies (also “microplates” herein) are provided for polymerase chain reaction (PCR). Microplates of the present disclosure may provide various advantages over current PCR systems, as rapid and accurate thermal control during PCR. In some embodiments, microplates are provided that can perform at least about 0.1, 1, 2, 3, 4, 5, 6, 7, 8, 9, 10, 20, 30, 40, 50, 60, 70, 80, 90, 100, 200, 300, 400, 500, 1000 PCR cycles per minute, or at most about 1, 2, 3, 4, 5, 6, 7, 8, 9, 10, 20, 30, 40, 50, 60, 70, 80, 90, 100, 200, 300, 400, 500, 1000, or 2000 PCR cycles per minute, or between about 1-60, 10-70, 20-80, 30-90, 40-100, 100-200, 200-300, 300-400, 500-1000 PCR cycles per minute, in some cases with fluorescence measurements every cycle. In another embodiment, microplates are provided having an average heating ramp rate of at least about 0.01° C./second, or 0.1° C./second, or 1° C./second, or 2° C./second, or 3° C./second, or 4° C./second, or 5° C./second, or 6° C./second, or 7° C./second, or 8° C./second, or 9° C./second, or 10° C./second, or 11° C./second, or 12° C./second, or 13° C./second, or 14° C./second, or 15° C./second, or 16° C./second, or 17° C./second, or 18° C./second, or 19° C./second, or 20° C./second, or 25° C./second, or 30° C./second, or 35° C./second, or 40° C./second, or 45° C./second, or 50° C./second, 100° C./second, or more, or at most about 0.01° C./second, or 0.1° C./second, or 1° C./second, or 2° C./second, or 3° C./second, or 4° C./second, or 5° C./second, or 6° C./second, or 7° C./second, or 8° C./second, or 9° C./second, or 10° C./second, or 11° C./second, or 12° C./second, or 13° C./second, or 14° C./second, or 15° C./second, or 16° C./second, or 17° C./second, or 18° C./second, or 19° C./second, or 20° C./second, or 25° C./second, or 30° C./second, or 35° C./second, or 40° C./second, or 45° C./second, or 50° C./second, 100° C./second, or more, or between about 1° C./second-10° C./second, or about 10° C./second-20° C./second, or about 20° C./second-30° C./second, or about 30° C./second-40° C./second, or about 40° C./second-50° C./second. In another embodiment, microplates may have active control over thermal uniformity, producing thermal control to within +/-2° C., +/-1° C., +/-0.5° C., +/-0.2° C., +/-0.1° C., +/-0.05° C. or better.

In some embodiments, microplates may be consumable. In another embodiment, microplates may be recyclable. In another embodiment, microplates may be reusable. In another embodiment, microplates may be biodegradable. In another embodiment, the microplates may be non-consumable.

An aspect of the present disclosure provides a microplate for polymerase chain reaction (PCR). In embodiments, the microplate may comprise a substrate including a metallic material for heating PCR samples and a barrier layer disposed over the substrate, the barrier layer formed of a first polymeric material. The microplate further may include one or more wells for containing PCR samples, the one or more wells formed of a second polymeric material sealed to the barrier layer. In some cases, the first polymeric material may be different from the second polymeric material. In an example, the first polymeric material may have a different glass transition temperature than the second polymeric material. In other cases, the first polymeric material may be the same as the second polymeric material. In an example, the first polymeric material may have the same or substantially the same glass transition temperature as the second polymeric material.

In some embodiments, the substrate may provide a PCR ramp rate (or heating rate) of at least about 0.01° C./second, or 0.1° C./second, or 1° C./second, or 2° C./second, or 3° C./second, or 4° C./second, or 5° C./second, or 6° C./second, or 7° C./second, or 8° C./second, or 9° C./second, or 10° C./second, or 11° C./second, or 12° C./second, or 13° C./second, or 14° C./second, or 15° C./second, or 16° C./second, or 17° C./second, or 18° C./second, or 19° C./second, or 20° C./second, or 25° C./second, or 30° C./second, or 35° C./second, or 40° C./second, or 45° C./second, or 50° C./second, or 100° C./second, or more, or at most about 0.1° C./second, or 1° C./second, or 2° C./second, or 3° C./second, or 4° C./second, or 5° C./second, or 6° C./second, or 7° C./second, or 8° C./second, or 9° C./second, or 10° C./second, or 11° C./second, or 12° C./second, or 13° C./second, or 14° C./second, or 15° C./second, or 16° C./second, or 17° C./second, or 18° C./second, or 19° C./second, or 20° C./second, or 25° C./second, or 30° C./second, or 35° C./second, or 40° C./second, or 45° C./second, or 50° C./second, or 100° C./second, or more, or between about 1° C./second-10° C./second, or about 10° C./second-20° C./second, or about 20° C./second-30° C./second, or about 30° C./second-40° C./second, or about 40° C./second-50° C./second, or about 50° C./second-60° C./second.

In some embodiments, heating of PCR samples may be achieved by passing electric current through the substrate. In another embodiment, heating of PCR samples may be achieved by passing direct current (DC) through the substrate (direct resistive heating). In some embodiments, heating may comprise using electric current to raise the temperature of a temperature block or unit containing a resistive heating element and contacting the temperature block or unit with the microplate without passing electric current through the substrate directly (i.e., not by direct resistive heating). In some embodiments, the temperature block may apply infrared radiation to heat the microplate, while still exerting an upward force to press the microplate to the heatable lid.

In some embodiments, the substrate may be separated from a PCR sample by 1 micrometer (“micron”) or less, or 2 microns or less, or 3 microns or less, or 4 microns or less, or 5 microns or less, or 6 microns or less, or 7 microns or less, or 8 microns or less, or 9 microns or less, or 10 microns or less, or 11 microns or less, or 12 microns or less, or 13 microns or less, or 14 microns or less, or 15 microns or less, or 16 microns or less, or 17 microns or less, or 18 microns or less, or 19 microns or less, or 20 microns or less. In other embodiments, the substrate may be separated from a PCR sample by at least about 0.1 microns, or 1 micron, or 2 microns, or 3 microns, or 4 microns, or 5 microns, or 10 microns, or 15 microns, or 20 microns, or 30 microns, or 40 microns, or 50 microns, or 100 microns, or 500 microns, or 1000 microns, or 5000 microns, or 10,000 microns, or more, or about 1 micrometer (“micron”) or more, or 2 microns or more, or 3 microns or more, or 4 microns or more, or 5 microns or more, or 6 microns or more, or 7 microns or more, or 8 microns or more, or 9 microns or more, or 10 microns or more, or 11 microns or more, or 12 microns or more, or 13 microns or more, or 14 microns or more, or 15 microns or more, or 16 microns or more, or 17 microns or more, or 18 microns or more, or 19 microns or more, or 20 microns or more. In other embodiments, the substrate is separated from a PCR sample by at least about 0.1 microns, or 1 micron, or 2 microns, or 3 microns, or 4 microns, or 5 microns, or 10 microns, or 15 microns, or 20 microns, or 30 microns, or 40 microns, or 50 microns, or 100 microns, or 500 microns, or 1000 microns, or 5000 microns, or 10,000 microns, or more.

In some embodiments, the second polymeric material may be heat-sealed to the barrier layer. In another embodiment, the first polymeric material may be chemically compatible with the second polymeric material. In some embodiments, the metallic material may comprise aluminum. In some embodiments, the metallic material may comprise an aluminum alloy. In some embodiments, the metallic material may comprise nickel. In some embodiments, the metallic material may comprise steel. In some embodiments, the metallic material may comprise copper. In some embodiments, the metallic material may comprise silver. In some embodiments, the metallic material may comprise gold. In some embodiments, the metallic material may comprise molybdenum. In some embodiments, the metallic material may comprise brass.

In some embodiments, the substrate may be for generating heat upon the flow of electrical current through the substrate. In another embodiment, the substrate may be for generating heat upon the flow of direct current (DC) through the substrate. In another embodiment, the substrate may be for generating heat upon the flow of alternating current (AC) through the substrate.

In some embodiments, the substrate may be for increasing the temperature of a sample in the one or more wells at a rate between about 0.01° C./second and 100° C./second, or between about 0.1° C./second and 50° C./second, or between about 1° C./second and 35° C./second, or between about 3° C./second and 25° C./second, or between about 5° C./second and 15° C./second. The substrate may be for increasing the temperature at least about 0.01° C./second, or at least about 0.1° C./second, or at least about 1° C./second, or at least about 10° C./second, or at least about 20° C./second, or at least about 30° C./second. The substrate may be for increasing the temperature at most about 0.01° C./second, or at most about 0.1° C./second, or at most about 1° C./second, or at most about 10° C./second, or at most about 20° C./second, or at most about 30° C./second.

In some embodiments, the substrate may include a metallic material for heating PCR samples. The metallic material may have a resistivity between about 5×10-9 ohm-m and 1×10-6 ohm- m, or between about 1×10-8 ohm-m and 1×10-7 ohm-m, or between about 2×10-8 ohm-m and 8×10-8 ohm m.

In some embodiments, the microplate can include one or more wells. In some cases, the microplate can include about 1 well, or 2 wells, or 3 wells, or 4 wells, or 5 wells, or 6 wells, or 7 wells, or 8 wells, or 9 wells, or 10 wells, or 11 wells, or 12 wells, or 13 wells, or 14 wells, or 15 wells, or 16 wells, or 17 wells, or 18 wells, or 19 wells, or 20 wells, or 21 wells, or 22 wells, or 23 wells, or 24 wells, or 25 wells, or 26 wells, or 27 wells, or 28 wells, or 29 wells, or 30 wells, or 31 wells, or 32 wells, or 33 wells, or 34 wells, or 35 wells, or 36 wells, or 37 wells, or 38 wells, or 39 wells, or 40 wells, or 41 wells, or 42 wells, or 43 wells, or 44 wells, or 45 wells, or 46 wells, or 47 wells, or 48 wells, or 49 wells, or 50 wells, or 51 wells, or 52 wells, or 53 wells, or 54 wells, or 55 wells, or 56 wells, or 57 wells, or 58 wells, or 59 wells, or 60 wells, or 61 wells, or 62 wells, or 63 wells, or 64 wells, or 65 wells, or 66 wells, or 67 wells, or 68 wells, or 69 wells, or 70 wells, or 71 wells, or 72 wells, or 73 wells, or 74 wells, or 75 wells, or 76 wells, or 77 wells, or 78 wells, or 79 wells, or 80 wells, or 81 wells, or 82 wells, or 83 wells, or 84 wells, or 85 wells, or 86 wells, or 87 wells, or 88 wells, or 89 wells, or 90 wells, or 91 wells, or 92 wells, or 93 wells, or 94 wells, or 95 wells, or 96 wells, or 97 wells, or 98 wells, or 99 wells, or 100 wells, or 101 wells, or 102 wells, or 103 wells, or 104 wells, or 105 wells, or 106 wells, or 107 wells, or 108 wells, or 109 wells, or 110 wells, or 111 wells, or 112 wells, or 113 wells, or 114 wells, or 115 wells, or 116 wells, or 117 wells, or 118 wells, or 119 wells, or 120 wells, or 121 wells, or 122 wells, or 123 wells, or 124 wells, or 125 wells, or 126 wells, or 127 wells, or 128 wells, or 129 wells, or 130 wells, or more. In some embodiments, the microplate can include 1 or more, or 5 or more, or 10 or more, or 15 or more, or 20 or more, or 25 or more, or 30 or more, or 35 or more, or 40 or more, or 45 or more, or 50 or more, or 60 or more, or 70 or more or 80 or more, or 90 or more, or 100 or more, or 110 or more, or 120 or more, or 130 or more, or 140 or more, or 150 or more, or 200 or more, or 300 or more, or 400 or more, or 500 or more, or 1000 or more wells. In some embodiments, the microplate can include 1 or fewer, or 5 or fewer, or 10 or fewer, or 15 or fewer, or 20 or fewer, or 25 or fewer, or 30 or fewer, or 35 or fewer, or 40 or fewer, or 45 or fewer, or 50 or fewer, or 60 or fewer, or 70 or fewer, or 80 or fewer, or 90 or fewer, or 100 or fewer, or 110 or fewer, or 120 or fewer, or 130 or fewer, or 140 or fewer, or 150 or fewer, or 200 or fewer, or 300 or fewer, or 400 or fewer, or 500 or fewer, or 1000 or fewer wells.

In an embodiment, the microplate may include 24 wells. In another embodiment, the microplate may include 48 wells. In another embodiment, the microplate can include 54 wells. In another embodiment, the microplate may include 72 wells. In another embodiment, the microplate may include 96 wells. The microplate can be disposable and/or recyclable.

In some embodiments, the microplate may include 24 wells, each well having a volume between 5 microliter (µl) and 40 µl fill, or 96 wells, each well having a volume between about 0.5 µl and 5 µl.

In other embodiments, a microplate for polymerase chain reaction (PCR) may comprise a substrate comprising a metallic material for heating PCR samples, a coating layer (also “barrier layer” herein) disposed over the substrate, the coating layer formed of a first polymeric material; and one or more wells formed of a second polymeric material sealed to the coating layer for containing PCR samples. In some embodiments, the second polymeric material may be the same as the first polymeric material. In some embodiments, the metal substrate may provide well-to-well thermal uniformity of +/- 2° C. or better, or +/- 1° C. or better, or +/- 0.5° C. or better, or +/- 0.2° C. or better, or +/- 0.1° C. or better, or +/- 0.05° C. or better, without the need for an external heating element or a Peltier heating block.

In other embodiments, a microplate for polymerase chain reaction (PCR) may comprise a substrate comprising a metallic material for heating PCR samples; a coating layer disposed over the substrate, the coating layer formed of a first polymeric material; and one or more wells for containing PCR samples, the one or more wells formed of a second polymeric material sealed to the coating layer. In some embodiments, the metal substrate may provide a heating efficiency sufficient to allow for at least 0.1 PCR cycles per minute, or at least 1 PCR cycle per minute, or at least 2 PCR cycles per minute, or at least 3 PCR cycles per minute, or at least 4 PCR cycles per minute, or at least 5 PCR cycles per minute, or at least 6 PCR cycles per minute, or at least 7 PCR cycles per minute, or at least 8 PCR cycles per minute, or at least 9 PCR cycles per minute, or at least 10 PCR cycles per minute, or at least 20 PCR cycles per minute, or at least 30 PCR cycles per minute, or at least 40 PCR cycles per minute, or at least 50 PCR cycles per minute, or at least 60 PCR cycles per minute, or at least 70 PCR cycles per minute, or at least 80 PCR cycles per minute, or at least 90 PCR cycles per minute, or at least 100 PCR cycles per minute, or at least 200 PCR cycles per minute, or at least 300 PCR cycles per minute, or at least 400 PCR cycles per minute, or at least 500 PCR cycles per minute, or at least 1000 PCR cycles per minute, in some cases including fluorescence measurement for every cycle. In some embodiments, the metal substrate may provide a heating efficiency sufficient to allow for at most 0.1 PCR cycles per minute, or at most 1 PCR cycle per minute, or at most 2 PCR cycles per minute, or at most 3 PCR cycles per minute, or at most 4 PCR cycles per minute, or at most 5 PCR cycles per minute, or at most 6 PCR cycles per minute, or at most 7 PCR cycles per minute, or at most 8 PCR cycles per minute, or at most 9 PCR cycles per minute, or at most 10 PCR cycles per minute, or at most 20 PCR cycles per minute, or at most 30 PCR cycles per minute, or at most 40 PCR cycles per minute, or at most 50 PCR cycles per minute, or at most 60 PCR cycles per minute, or at most 70 PCR cycles per minute, or at most 80 PCR cycles per minute, or at most 90 PCR cycles per minute, or at most 100 PCR cycles per minute, or at most 200 PCR cycles per minute, or at most 300 PCR cycles per minute, or at most 400 PCR cycles per minute, or at most 500 PCR cycles per minute, or at most 1000 PCR cycles per minute, in some cases including fluorescence measurement for every cycle. In some embodiments, the metal substrate provides a heating efficiency sufficient to allow for between 1-10 PCR cycle per minute, or 10-20 PCR cycles per minute, or 20-30 PCR cycles per minute, or 30-40 PCR cycles per minute, or 40-50 PCR cycles per minute.

In some embodiments, the microplate further may include a layer of an infrared radiation (IR)-normalizing material at a side of the substrate opposite the contact layer. The IR normalizing layer may aid in increasing IR emissivity, thereby providing for more efficient thermal regulation of the microplate and the one or more wells during PCR. In another embodiment, the microplate may comprise a layer of an IR-normalizing material at a side of the substrate opposite the coating layer. In some embodiments, the IR-normalizing layer may have a thickness less than about 10 micrometers (“microns”), or less than about 5 microns, or less than about 1 micron, or less than about 0.5 microns, or less than about 0.1 microns.

In some embodiments, the microplate may have a thickness less than about 0.1 mm, or less than about 0.2 mm, or less than about 0.3 mm, or less than about 0.4 mm, or less than about 0.5 mm, or less than about 0.6 mm, or less than about 0.7 mm, or less than about 0.8 mm, or less than about 0.9 mm, or less than about 1 mm. In another embodiment, the microplate may have a thickness between about 0.1 mm and 100 mm, or between about 0.2 mm and 20 mm, or between about 0.3 mm and 10 mm, or between about 0.4 mm and 0.6 mm. In some embodiments, the microplate may have a thickness greater than about 0.1 mm, or greater than about 0.2 mm, or greater than about 0.3 mm, or greater than about 0.4 mm, or greater than about 0.5 mm, or greater than about 0.6 mm, or greater than about 0.7 mm, or greater than about 0.8 mm, or greater than about 0.9 mm, or greater than about 1 mm.

In some embodiments, the coating layer may have a thickness less than about 10 micrometers (“microns”), or less than about 5 microns, or less than about 1 micron, or less than about 0.5 microns, or less than about 0.1 microns. In some embodiments, the coating layer may have a thickness greater than about 10 micrometers (“microns”), or greater than about 5 microns, or greater than about 1 micron, or greater than about 0.5 microns, or greater than about 0.1 microns. In some embodiments, the coating layer may have a thickness of between about 0.1 and 1 microns, of between about 1 and 2 microns, of between about 2 and 3 microns, of between about 3 and 5 microns, or of between about 5 and 10 microns.

Another aspect of the present disclosure may provide disposable sample holders for use with polymerase chain reaction (PCR). The disposable sample holders in some cases are formed of a recyclable material, such as a polymeric material, a metallic material (e.g., aluminum), or a composite material.

In some embodiments, a disposable sample holder may comprise an aluminum substrate coated with a first polymeric material and a plurality of wells heat-sealed to the first polymeric material. The plurality of wells can be formed of a second polymeric material compatible with the first polymeric material.

In some cases, a disposable sample holder may comprise an aluminum-containing substrate for providing heat to a plurality of wells of the disposable sample holder. The disposable sample holder can have a weight less than or equal to about 100 g, or 90 g, or 80 g, or 70 g, or 60 g, or 50 g, or 40 g, or 30 g, or 20 g, or 15 g, or 10 g, or 5 g, or 4 g, or 3 g, or 2 g, or 1 g, or lower. The disposable sample holder can have a weight greater than or equal to about 1 g, or 2 g, or 5 g, or 10 g, or 15 g, or 20 g, or 30 g, or 40 g, or 50 g, or 60 g, or 70 g, or 80 g, or 90 g, or 100 g. In some embodiments, the sample holder may have a weight between 1 and 10 g, between 10 and 20 g, between 20 and 30 g, between 30 and 40 g, between 40 and 50 g, between 50 and 100 g, or greater. In some embodiments, the disposable sample holder is a single-use sample holder. In some embodiments, the disposable sample holder is a multiple-use sample holder.

Another aspect of the present disclosure may provide a low-cost sample holder for use with polymerase chain reaction (PCR). The low-cost sample holder can comprise a substrate formed of a metallic material having a density between about 2.0 g/cm3 and 4.0 g/cm3, or 2.7 g/cm3 and 3.0 g/cm3. The substrate can be configured to provide heat to one or more wells of the low-cost sample holder at a heating rate between about 0.01° C./second and 100° C./second, or between about 0.1° C./second and 50° C./second, or between about 1° C./second and 35° C./second, or between about 3° C./second and 25° C./second, or between about 5° C./second and 15° C./second. In some embodiments, the substrate includes aluminum. In some situations, the low-cost sample holder further may include a barrier layer formed of a first polymeric material over the substrate. The one or more wells of the low-cost sample holder may be formed of a second polymeric material joined to the first polymeric material.

### Thermocycler System

Disclosed is an ultra-fast thermocycler system, which may be capable of performing 40 PCR cycles within 25 minutes. In some embodiments, the thermocycler may perform about 20 PCR cycles in 10 minutes, or about 30 PCR cycles in 10 minutes, or about 40 PCR cycles in 10 minutes, or about 50 PCR cycles in 10 minutes. In some embodiments, the thermocycler may perform about 20 PCR cycles in 20 minutes, or about 30 PCR cycles in 20 minutes, or about 40 PCR cycles in 20 minutes. In some embodiments, the thermocycler may perform about 20 PCR cycles in 30 minutes, or about 30 PCR cycles in 30 minutes, or about 40 PCR cycles in 30 minutes. In some embodiments, the thermocycler may perform about 10-20 PCR cycles in 10 minutes, or about 20-30 PCR cycles in 10 minutes, or about 30-40 PCR cycles in 10 minutes, or about 40-50 PCR cycles in 10 minutes. In some embodiments, the thermocycler may perform about 10-20 PCR cycles in 20 minutes, or about 20-30 PCR cycles in 20 minutes, or about 30-40 PCR cycles in 20 minutes. In some embodiments, the thermocycler may perform about 10-20 PCR cycles in 30 minutes, or about 20-30 PCR cycles in 30 minutes, or about 30-40 PCR cycles in 30 minutes. In some embodiments, the thermocycler may perform about 20 PCR cycles in 10-20 minutes, or about 30 PCR cycles in 10-20 minutes, or about 40 PCR cycles in 10-20 minutes, or about 50 PCR cycles in 10-20 minutes. In some embodiments, the thermocycler may perform about 20 PCR cycles in 20-30 minutes, or about 30 PCR cycles in 20-30 minutes, or about 40 PCR cycles in 20-30 minutes. In some embodiments, the thermocycler may perform about 20 PCR cycles in 30-40 minutes, or about 30 PCR cycles in 30-40 minutes, or about 40 PCR cycles in 30-40 minutes.

The thermocycler system may include a microplate supported by a carriage for transferring the microplate rapidly between heated blocks. One heated block (e.g., a temperature block or temperature unit) may heat the microplate to an extension temperature and the other heated block may heat the microplate to a denaturing temperature. An optical scanner may track the progress of the thermocycling reaction by taking fluorescence measurements.

The microplate may be a thin, two-sided, rigid, non-deforming plate. The microplate may be made of a metallic material (e.g., aluminum). On one side, the plate may be coated with a polymeric material (e.g., polypropylene) and affixed with sample containment wells. On the other side, the microplate may include a bar code to be scanned by a bar code scanner disposed underneath the microplate. The microplate may include alignment notches for precisely locating the microplate within the thermocycling system.

The temperature blocks (also referred to as heating blocks or temperature units) may provide heat to the microplate samples for extension, annealing, and denaturing. The temperature blocks may provide electrical heating (e.g., resistive heating) to the microplate, or may heat via infrared heating or by another method.

The optical scanner may be a fluorescence sensor. The optical scanner may include a plurality of light-emitting diodes (LEDs) which may excite fluorescence in wells undergoing thermocycling. Photodiodes or other devices may then measure the fluorescence.

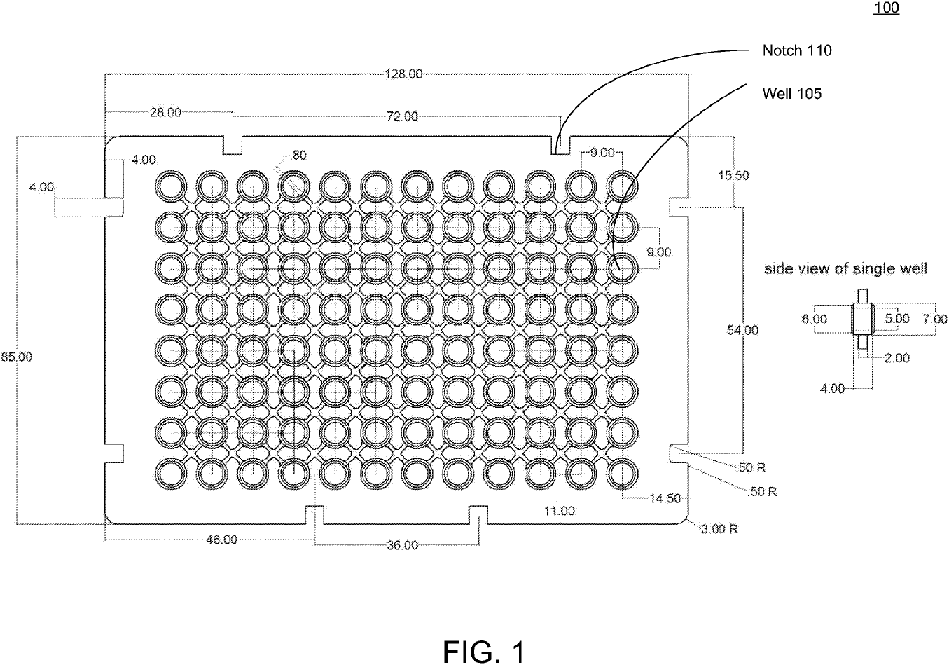

FIG. 1 illustrates a a microplate 100, in accordance with an embodiment. The microplate may hold a plurality of deoxyribonucleic acid (DNA)-containing samples within its wells which are amplified (e.g., via polymerase chain reaction (PCR)) by the thermocycler. The microplate 100 has 96 wells 105, but in other embodiments, the microplate may have 6, 12, 24, 48, 192, 384, or 1536 wells, arranged in a 2:3 rectangular matrix (e.g., quantitative PCR (qPCR) test plates in standard Society for Biomolecular Sciences (SBS) sizes). The microplate 100 may be an aluminum plate, coated on one side with polypropylene to enable it to withstand wide changes in temperature typical of the PCR process. The aluminum plate may be thin (e.g., 0.4 mm) with the coating also thin (e.g. 0.01 \.mm). The coating may be applied as a liquid and heat treated to cure it and bond it to the aluminum plate. The wells may additionally be made of rigid polypropylene, and may be welded to the polypropylene-coated side of the plate. In other embodiments, the wells and coating may comprise different materials. In the embodiment 100, the wells and coating may be white, but in other embodiments, the coating and/or wells may be frosted (or translucent) to avoid oversaturation of the sensing device, or may be of different colors. Once the sample wells are loaded, the sample wells may be sealed with a heat seal film (e.g., a polypropylene, polyethylene, polyester lid, or laminated film). In the 96-well plate 100, an individual sample well 105 may comprise a stepped section ring. The stepped section ring may comprise a large ring and a smaller ring joined together. The diameter of the internal ring may be 5 mm. The depth of the internal ring may be 4 mm. The wells may be formed of a polymeric material. This can provide for efficient thermal control in each of the wells 105.

The microplate may include one or more sides in addition to the coated side containing the microplate wells 105. An underside (i.e., a reverse side of or an opposite side of) of the microplate may include a bar code situated so that a bar code scanner disposed underneath the microplate can read the types of samples and/or reagents inside the wells.

The microplate 100 may have one or more notches 110 for locating the microplate in a consistent position on the heater block, as well as aligning with the sensors for signal measurement. The notches 110 may be used to align the microplate 100 precisely below a signal measurement system and above a barcode reader. In this embodiment, the notches may be cut to be rectangular in shape, but may be triangular, circular, or another shape needed for alignment within a thermocycling system. The notches may be 4 mm in width by 4 mm in height. The notch width may be about at least 1 mm, about at least 2 mm, about at least 3 mm, about at least 4 mm, or about at least 5 mm. The notch width may be about at most 2 mm, about at most 3 mm, about at most 4 mm, about at most 5 mm, or about at most 6 mm. The notch width may be between about 1 mm and 2 mm, between about 2 mm and 3 mm, between about 3 mm and 4 mm, between about 4 mm and 5 mm, or between about 5 mm and 6 mm. The notch height may be about at least 1 mm, about at least 2 mm, about at least 3 mm, about at least 4 mm, or about at least 5 mm. The notch height may be about at most 2 mm, about at most 3 mm, about at most 4 mm, about at most 5 mm, or about at most 6 mm. The notch height may be between about 1 mm and 2 mm, between about 2 mm and 3 mm, between about 3 mm and 4 mm, between about 4 mm and 5 mm, or between about 5 mm and 6 mm. In this embodiment, the notches are of uniform size, but in alternate embodiments, the notches may be of different sizes. The microplate 100 includes eight alignment notches, but other embodiments may have more or fewer notches for alignment. The notches 110 may perform alignment with the thermocycler components by ensuring that the microplate 100 travels along vertical guide rails.

In some embodiments, one rectangular side of the microplate may have notches, or two rectangular sides may have notches, or three rectangular sides may have notches, or four rectangular sides may have notches. In some embodiments, there may be 1 notch, or 2 notches, or 4 notches, or 8 notches, or 16 notches. In some embodiments, the notches may be spaced apart by 1 mm, or 2 mm, or 3 mm, or 4 mm, or 6 mm, or 12 mm, or 18 mm, or 24 mm, or 36 mm, or 54 mm, or 72 mm. In some embodiments, opposite rectangular side may comprise notches. In some embodiments, adjacent rectangular sides may comprise notches. The notches may not have identical spacings on each rectangular side. In one embodiment, there may be eight notches. On one long rectangular side, they may be spaced 36 mm apart. On two opposite short rectangular sides, they may be spaced 54 mm apart. On the remaining long rectangular side, they may be spaced 72 mm apart.

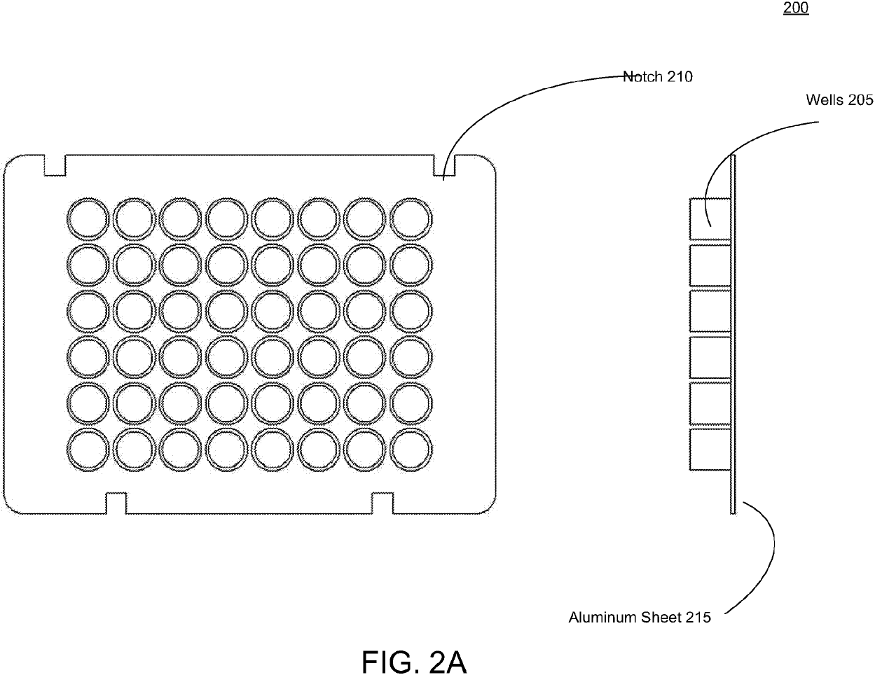

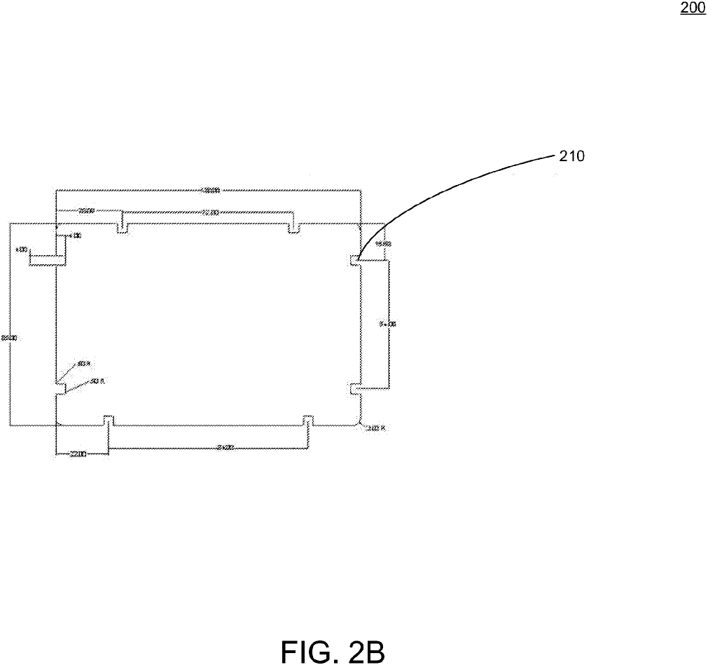

FIGS. 2A-B illustrate side and front views of an alternate 48-well microplate embodiment 200 with rigid polypropylene wells 205 welded to an aluminum sheet 215, with alignment notches 210. The microplate 200 can be polymer-coated. The polymer coating may comprise a polypropylene, polycarbonate, or other coating.

In various embodiments, the wells 205 may be arranged in array formats including 4×6, 6×8, 8×12, 16×24, or other 2:3 rectangular well arrangements. The wells may have 9 mm or 4.5 mm or 2.25 mm square pitches, to suit industry standard, automated liquid handling equipment with industry standard geometry and dimension. The size of the microplate, the sizes and pitches of the wells in the microplate, and the 2:3 ratio for rectangular well arrangements or arrays enable post-test procedures using standard equipment. In some embodiments, the microplate may have alternative arrangements of wells within the array. For example, the microplate may have a 1:2 arrangement, a 2:4 arrangement, a 2:5 arrangement, a 3:4 arrangement, a 3:5 arrangement, or a 4:5 arrangement.

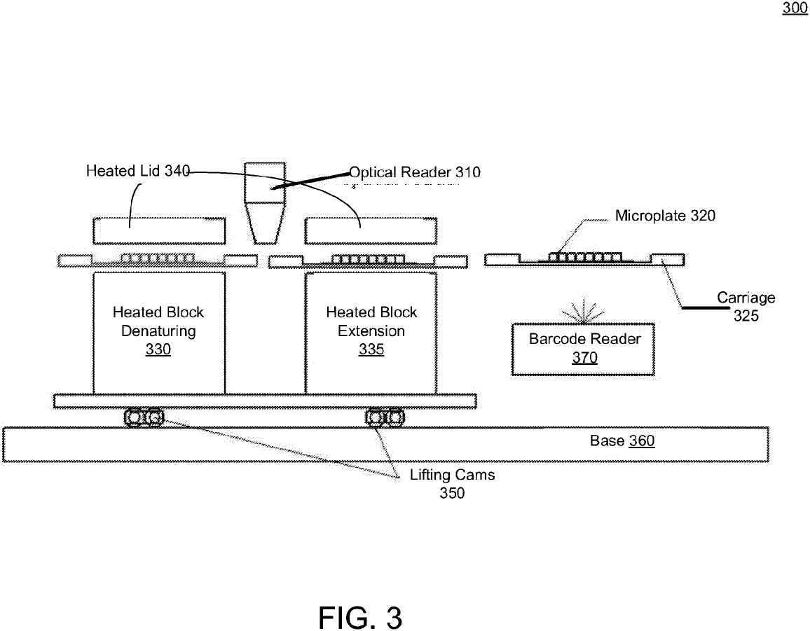

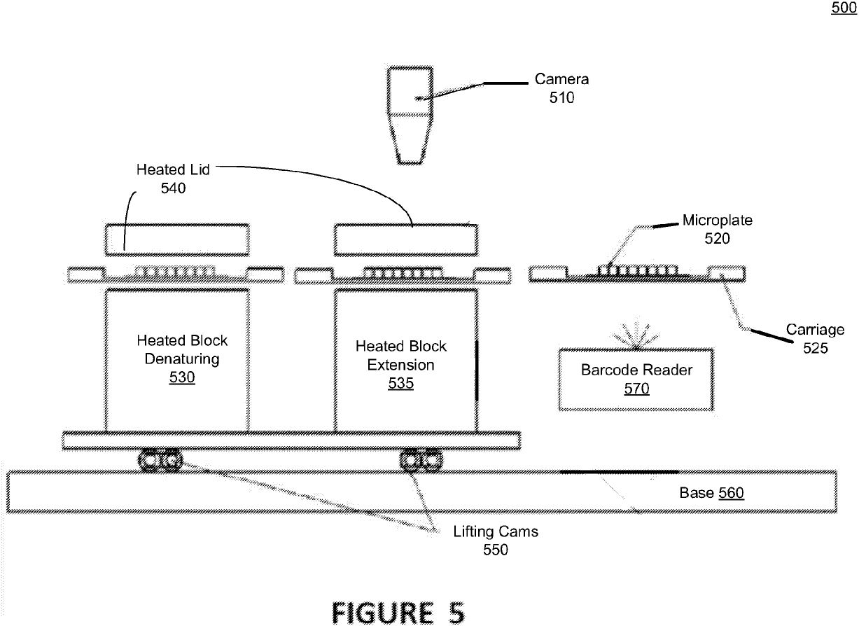

A carriage mounted on a conveyor may be used to locate and support the microplate 100 or microplate 200 using their alignment features, and to move them linearly as required. The conveyor may comprise rails, while the microplate may be actuated by a leadscrew or toothed belt to traverse the rails. To carry out the alternate heating and cooling required for PCR, the microplate 100 or 200 may be moved rapidly (e.g, at 250 mm/s) backwards and forwards between two electrically heated, temperature-controlled blocks set to the denaturing and the extension temperatures of the reagents, (e.g., 95 and 55° C.), and clamped firmly to each in turn, for a pre-set time. For example, the microplate 100 or 200 may be clamped for one to two seconds to the denaturing block (e.g., block 330 of FIG. 3 or block 530 of FIG. 5) and four to ten seconds, dependent on length of the DNA target sequence, clamped to the extension block.

The progress of the PCR may be followed by using fluorescence measurements from the samples contained in each ring 205. While the plate 200 moves between the blocks when thermal cycling, it may pass under a sensing device. The sensing device may be an optical reader (e.g., a fluorescence detector). In some embodiments, the sensing device may illuminate an array of wells normal to the direction of motion of the microplate with a controlled wavelength of light and then may measure the fluorescent response from each ring. This may be repeated for each of the lines of wells 205 in the direction of motion. In other embodiments, the sensing device may illuminate an array of wells not normal to the direction of motion of the microplate.

Where different fluorophores are read from each well, additional sensing devices may be used to detect fluorescence for each wavelength of light emitted. The detectors may sit in a line between the two blocks.

The microplate 200 may include a thin (e.g., 0.4 mm), polymer-coated aluminum sheet with tolerances of e.g., ±0.15 on positions or ±0.2 on radii. One side of the sheet may be black (by the addition of carbon, for improved detection for fluorescent biological assays) and the other may be white. In other embodiments, the polymer coating may be frosted (i.e., translucent) or may be another color.

FIG. 3 illustrates a diagram of the ultrafast PCR thermocycler 300, in accordance with an embodiment. The thermocycler 300 may include a microplate 320, which may be a similar microplate to the microplate 100 or the microplate 200, a carriage 325 to mount the microplate 320, a sensing device 310, a plurality of heatable lids 340, a heated block for denaturing 330, a heated block for extension 335, a plurality of lifting cams 350, and a barcode reader 370. The components may sit on a base 360. The thermocycler may transfer the samples between the heated blocks 330 and 335 between 10 and 60 times using robotic or mechanical handling. In some embodiments, the thermocycler may include a liquid handling/autopipette platform with auto-sealing and robotic handling of the microplate.

In the embodiment of FIG. 3, the heated block 335 may provide the extension and annealing temperatures. But in other embodiments, the PCR thermocycler may have three or more heated blocks. For example, a three-block thermocycler may have one block for extension, one block for annealing, and one block for denaturing. Such a thermocycler may have multiple sensing devices for making measurements of the reaction as the microplate moves from the first block to the second, the second block to the third, or the third block back to the first. The carriage 325 may support the microplate 320 and moves it through the thermocycler. The carriage may be a substantially flat platform made of a material that can resist the heat provided by the heated blocks 330 and 335.

The carriage may be made of a metal. The metal may be chromium. The metal may be copper. The metal may be iron. The metal may be magnesium. The metal may be nickel. The metal may be titanium. The metal may be zinc. The metal may be silicon. The metal may be an alloy of one or more of the aforementioned metals. The metal may be steel. The carriage may be made of a heat-resistant polymer. The polymer may be polyetherimide. The polymer may be polyether ether ketone. The polymer may be polytetrafluoroethylene. The polymer may be polybenzimidazole. The polymer may be polydicyclopentadiene.

The carriage may have an opening on its underside so that the barcode on the underside of the microplate may be read by the barcode scanner. To move the microplate and samples between the blocks, the carriage may be placed on a track or conveyor, or may be attached to an actuator to transfer it rapidly between blocks.

In the embodiment 300 of FIG. 3, there may be three carriage positions between which a carriage 325 moves, carrying the plate 320. The positions may include load/unload, (at 370), extension, (at 335), and denaturing, (at 330). In the load/unload position, the microplate may be placed in the thermocycler and initially scanned by bar code reader 370. During cycling, the carriage 325 may move backwards and forwards between the denaturing heated block 330 and extension heated block 335.

When the carriage 325 is stationary over denaturing heated block 330 or extension heated block 335, the lifting cams 350 may raise the block to clamp the microplate 320 to the heatable lid 340 with a force of 10-300 newtons (N). Clamping (or pressing) the microplate between either heated block and the heatable lid increases a rate of heat transfer between the block and the microplate 320, to produce heat transfer times of less than ten seconds for extension and less than 30 seconds for denaturing. Raising the heated block through the carriage and pressing it with considerable force against the heatable lid, may ensure that no condensation forms on the underside of the sealing film and also may generate even and intimate contact between the underside of the uncoated aluminum face of the microplate and the heated block. This intimate contact may allow the dissipation of heat from the microplate 320 to be both even and quickly as possible transmitted across the whole aluminum surface of the microplate 320 when cooling the microplate 320 down from the denaturing temperature on the extension and annealing temperature block. Additionally, the intimate contact may quicken and make more even the heating of the microplate 320 when contacting the microplate 320 on the denaturing temperature block. The lower extension temperature block may require cooling in order to dissipate heat from the microplate 320 so that the correct temperature is achieved for the extension reaction to occur.

A heated block may heat the sample using electrical heating, such as resistive or Joule heating. For example, the heated block may comprise one or more electrically conductive elements that heat when supplied with an electric potential. Additionally, the samples in the microplate could be heated using an infrared heating device, such as a heat lamp. The extension temperature may be within a range of about 50° C. to 65° C., or within a range of about 52° C. to 57° C. The denaturing temperature may be within a range of about 90° C. to 100° C., or within a range of about 92° C. to 97° C. Heated block for denaturing 330 may provide the denaturing temperature for about 1 to 10 seconds and heated block for extension 335 may provide the extension temperature for about 1 to 30 seconds. In some embodiments, heated block for denaturing 330 may provide the denaturing temperature for about one to two seconds and heated block for extension 335 may provide the extension temperature for about four to ten seconds.

The sensing device 310 may measure the progress of the PCR process in the microplate wells, by taking fluorescence measurements as the microplate 320 transitions between the extension temperature zone and the denaturing temperature zone. In the embodiment of FIG. 3, the sensing device may be an optical reader. The optical reader may measure fluorescence from the progressing reaction. In other embodiments, the optical reader may measure another quantity, such as chemiluminescence or fluorescence polarization. The samples may be treated with a fluorescent dye that may insert themselves inside double-stranded DNA. Or, nucleic acid probes that are labeled with fluorescent reporters may be placed in the sample and may emit fluorescent signals upon hybridization. When the microplate moves between heating blocks, the sensing device may detect the fluorescence of the microplate wells. The fluorescence measurements may all be collected at a common temperature. The sensing device may include a light-emitting diode (LED) that shines light on one or more of the microplate wells. The sample in the well may emit fluorescence, which may be detected by one or more photodiodes within the sensing device. In some embodiments, the sensing device may make ultra-rapid fluorimetry measurements using CMOS and CCD static cameras and video cameras, photodiodes, optodiodes, silicon photomultipliers (SiPMs) or spectrometers. Some spectrometers used may have light emitting diode (LED) illumination and multiple filter sets in order to detect and measure narrow wavebands of light.

A thermocycler run may proceed as follows. A loaded and sealed microplate 320 may be placed on the carriage 325 at the load/unload position. The barcode on the bottom of the microplate 320 may be read and checked. The carriage 325 then may move to the extension position. The blocks 330, 335 may rise through the carriage, lifting the microplate 320 and clamping it against the heatable lid 340. The microplate 320 may be held in this position for 5-10 seconds to normalize the thermal conditions of the microplate 320, and to heat it to 50° C. for the initial “zero” fluorescence measurement. Because fluorescent output is always temperature dependent, so all measurements may be carried out at the same temperature.

The blocks 330, 335 may then be lowered, and the carriage 325 may move to the denaturing position 330. The microplate 320 may pass under the optical reader 310. As each row of wells pass under the reader 310, the light emitting diodes (LEDs) for each well position may be turned on for a few milliseconds and the fluorescent emission from each well may be measured using the photodiodes located at each well position. It may not be necessary to move slowly under the sensor, so at 200 mm/s the transit time between the blocks may be about 1.25 seconds. In other embodiments, the transit time may be between one and five seconds.

The heated blocks 330, 335 may be then raised to clamp the microplate 320 against the heatable lid. After a pre-set time, (e.g., two to three seconds), the blocks 330, 335 may be lowered, and the carriage 325 may be moved back to the extension position and clamped for a pre-set time, (e.g., five to ten seconds).

The carriage 325 then may move repeatedly between the denaturing and extension blocks 330 and 335, being clamped to each block. On every transition between the extension and denaturing block 330 and 335, fluorescent values may be recorded from a well. The alternate clamping to the blocks 330, 335 may continue for a pre-set number of cycles. On the last cycle, the carriage 325 moves from the extension position to the denaturing position, with fluorescent measurements, but may not clamp. Instead, it may just move back to the load/unload position and stop. A finished alert may be given.

The thermocycler system 300 disclosed may achieve a 40 cycle PCR in 10 minutes or less, 15 minutes or less, 20 minutes or less, 30 minutes or less, 40 minutes or less, 50 minutes or less, or one hour or less, without working at the limits of the machine performance. The system 300 disclosed may not be limited to 2-temperature PCR, a third or fourth temperature-controlled block can easily be added to the system.

FIG. 5 illustrates another embodiment of the real-time PCR or qPCR thermal cycler system. In the embodiment of FIG. 5, a camera 510 is placed above the lower temperature heater block 535 where the extension phase of the polymerase chain reaction may occur. The system 500 (e.g., thermocycler system) may comprise a barcode reader 570 to determine the content of a sample. The microplate 520 can move through the thermocycler system 500 on carriage 525. The heated blocks 530, 535 may be lifted to clamp the microplate 520 in place using the lifting cams 550. Again, the microplate 520 may rest on a carriage 525 as it progresses through the thermocycler 500.

The camera 510 may be configured for use with one or more filters and/or may collect image data to detect fluorescence from reactions occurring in wells positioned under a lid 540 (e.g., a coated glass heatable lid). The lid may comprise glass that is coated with a material (e.g., indium tin oxide (ITO)) having excellent electrical conductivity and optical transparency. When the system passes an electrical current through the ITO coating, the glass may be heated. This can prevent condensation forming on the lower surface of the sealing film on top of the microplate, which could obscure the samples and prevent detection of fluorescence measurements. If condensation formed on the lower surface, it may be difficult to quantify the progress of the PCR reaction within one or more wells.

The camera 510 may image all wells of the microplate 520 simultaneously through the lid 540 and sealing film (e.g., clear sealing film). The system may use filters for detection of specific wavelengths of light at which reporter dyes fluoresce within the one or more wells.

The temperature of the lower temperature heated block for extension 535 may remain constant and the microplate 520 containing the samples (e.g., biological samples) may move from the lower temperature block for extension 535 to an adjacent block 530 where the samples can denature at a higher temperature.

Following denaturation, the system may move the microplate 520 back to the extension block 535 (e.g., lower temperature block) and extension can occur within the samples. The heat cycling may be repeated multiple times (e.g., between 20 and 50 temperature cycles).

During real-time PCR or qPCR, the system may obtain an image and/or make one or more fluorescence measurements after the sample has been exposed to the lower temperature block and/or once the cycles’ extension has occurred.

When a predetermined number of cycles has been completed, a confirmatory test may be performed. The confirmatory test can comprise slowly raising the samples’ temperature in order to detect the exact temperature at which the deoxyribonucleic acid (DNA) strands denature or “melt” apart. The melting apart can be detected by a marked change in the level of fluorescence.

Different sequences of DNA can melt at different temperatures. The melt temperature may be compared to a known melt temperature for the specific product sequence to confirm that the sequence being melted is the specific sequence that the assay methods and systems (e.g., kit and experiment) were designed to amplify, rather than erroneous artifacts (e.g., primer dimers). Since the primer dimers can be shorter than the target DNA sequence, they may denature, (e.g., melt) at a lower temperature than the target sequence and so can easily be distinguished.

The lower temperature block for extension 535 can be heated and maintain at a constant temperature throughout the PCR amplification process (e.g., using heater cartridges). Once complete the temperature can be slowly raised to effect the melt confirmatory step.

In order to cool swiftly back to the original extension temperature for the next PCR method, the system 500 may heat the block with electrically powered heater cartridges and cool it by passing ambient air over the reverse surface using forced air from a compressor or a motorized fan. The system 500 may also heat and cool the lower temperature block using Peltier effect devices, which primarily would be used to maintain the heated block at a constant temperature.

In some cases, when the denaturing heater block 530 is separate from and adjacent to the extension temperature block 535, the time taken for the samples to change temperature may also be minimized. The system may perform qPCR imaging at the end of each extension period and high resolution melt curves may be obtained at the end of the appropriate number of cycles using the same or different fluorescence imaging system.

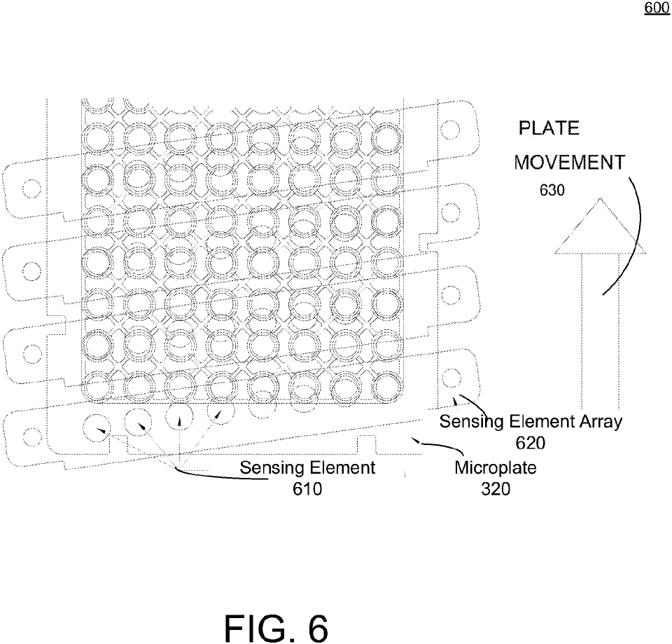

FIG. 6 illustrates a configuration 600 of the sensing device 310 that corrects crosstalk in fluorescence measurements from adjacent microplate wells. The sensing device 310 may comprise one or more sensing element arrays 620 that themselves may comprise one or more LEDs, one or more filters, and one or more photodiodes. The configuration places at angles the one or more arrays of sensing elements so that individual sensing elements are not simultaneously measuring fluorescence on adjacent microplate wells. Instead, the sensing elements 610 may measure fluorescence in a sequence (e.g., in order from the rightmost element to the leftmost element).

The sensing device configuration 600 may comprise a plurality of sensing element arrays 620. For example, each array may comprise eight sensing elements, for each of eight different fluorophores used in the assays contained on the sample plate. The plurality of sensing element arrays 620 may be angled, so that the arrays are not normally disposed with respect to the direction of plate movement 630. The angle of the element arrays 620 with respect to the direct of plate movement 630 may be between 0° and 90°. The angle may be between about 0° and 10°, between about 10° and 20°, between about 20° and 30°, between about 30° and 40°, between about 40° and 50°, between about 50° and 60°, between about 60° and 70°, between about 70° and 80°, or between about 80° and 90°.

As the microplate passes under a line of sensing elements 610, the wells containing the samples may align sequentially with each of the sensing elements in the line. An LED in an individual sensing element 610 only illuminates for a few milliseconds, as it is aligned with a particular well, and the photodiode measures the fluorescent output from the assay contained by the well only while its own LED is illuminated. In this embodiment, one sensing element 610 in the plurality of sensing element arrays 620 is active at any particular time, so light signals from one well cannot interfere with light signals from an adjacent well. In other embodiments, sensing element arrays may be shaped differently (e.g., curved) to enable more than one sensing element to be active at one time, while still eliminating crosstalk that would arise from adjacent sensing elements being active.

### Computer Control Systems

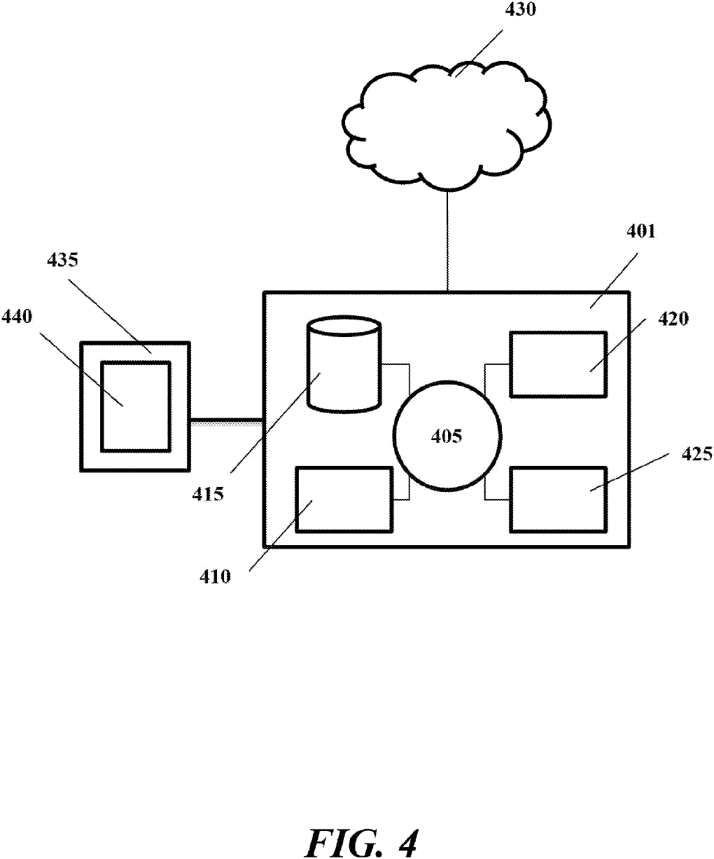

The present disclosure provides computer control systems that are programmed to implement methods of the disclosure. FIG. 4 shows a computer system 401 that is programmed or otherwise configured to analyze PCR data. The computer system 401 can regulate various aspects of regulating motion of the microplate of the present disclosure, such as, for example, adjusting the temperatures of the temperature blocks and rapidly transitioning the microplate between the temperature blocks. The computer system 401 can be an electronic device of a user or a computer system that is remotely located with respect to the electronic device. The electronic device can be a mobile electronic device.

The computer system 401 includes a central processing unit (CPU, also “processor” and “computer processor” herein) 405, which can be a single core or multi core processor, or a plurality of processors for parallel processing. The computer system 401 also includes memory or memory location 410 (e.g., random-access memory, read-only memory, flash memory), electronic storage unit 415 (e.g., hard disk), communication interface 420 (e.g., network adapter) for communicating with one or more other systems, and peripheral devices 425, such as cache, other memory, data storage and/or electronic display adapters. The memory 410, storage unit 415, interface 420 and peripheral devices 425 are in communication with the CPU 405 through a communication bus (solid lines), such as a motherboard. The storage unit 415 can be a data storage unit (or data repository) for storing data. The computer system 401 can be operatively coupled to a computer network (“network”) 430 with the aid of the communication interface 420. The network 430 can be the Internet, an internet and/or extranet, or an intranet and/or extranet that is in communication with the Internet. The network 430 in some cases is a telecommunication and/or data network. The network 430 can include one or more computer servers, which can enable distributed computing, such as cloud computing. The network 430, in some cases with the aid of the computer system 401, can implement a peer-to-peer network, which may enable devices coupled to the computer system 401 to behave as a client or a server.

The CPU 405 can execute a sequence of machine-readable instructions, which can be embodied in a program or software. The instructions may be stored in a memory location, such as the memory 410. The instructions can be directed to the CPU 405, which can subsequently program or otherwise configure the CPU 405 to implement methods of the present disclosure. Examples of operations performed by the CPU 405 can include fetch, decode, execute, and writeback.

The CPU 405 can be part of a circuit, such as an integrated circuit. One or more other components of the system 401 can be included in the circuit. In some cases, the circuit is an application specific integrated circuit (ASIC).

The storage unit 415 can store files, such as drivers, libraries and saved programs. The storage unit 415 can store user data, e.g., user preferences and user programs. The computer system 401 in some cases can include one or more additional data storage units that are external to the computer system 401, such as located on a remote server that is in communication with the computer system 401 through an intranet or the Internet.

The computer system 401 can communicate with one or more remote computer systems through the network 430. For instance, the computer system 401 can communicate with a remote computer system of a user (e.g., a scientist or lab technician). Examples of remote computer systems include personal computers (e.g., portable PC), slate or tablet PC’s (e.g., Apple® iPad, Samsung® Galaxy Tab), telephones, Smart phones (e.g., Apple® iPhone, Android-enabled device, Blackberry®), or personal digital assistants. The user can access the computer system 401 via the network 430.

Methods as described herein can be implemented by way of machine (e.g., computer processor) executable code stored on an electronic storage location of the computer system 401, such as, for example, on the memory 410 or electronic storage unit 415. The machine executable or machine-readable code can be provided in the form of software. During use, the code can be executed by the processor 405. In some cases, the code can be retrieved from the storage unit 415 and stored on the memory 410 for ready access by the processor 405. In some situations, the electronic storage unit 415 can be precluded, and machine-executable instructions are stored on memory 410.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 401, can be embodied in programming. Various aspects of the technology may be thought of as “products” or “articles of manufacture” typically in the form of machine (or processor) executable code and/or associated data that is carried on or embodied in a type of machine-readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine-readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 401 can include or be in communication with an electronic display 435 that comprises a user interface (UI) 440 for providing, for example, a way to move the microplate or change temperatures. Examples of UI’s include, without limitation, a graphical user interface (GUI) and web-based user interface.

Methods and systems of the present disclosure can be implemented by way of one or more algorithms. An algorithm can be implemented by way of software upon execution by the central processing unit 405. The algorithm can, for example, direct PCR cycles.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A system, comprising:
(a) a microplate for containing one or more samples during thermocycling, which microplate comprises a first side and a second side, which first side comprises a metallic material, wherein the microplate comprises one or more barcodes disposed on the first side or the second side;
(b) a barcode reader for reading the one or more barcodes;
(c) a first temperature block configured to receive the microplate and/or provide a denaturing temperature to the one or more samples contained in the microplate, during the thermocycling;
(d) a second temperature block configured to receive the microplate and/or provide an extension temperature to the one or more samples contained in the microplate, during the thermocycling; and
(e) a conveyor configured to move the microplate between a sensing device, the first temperature block, and the second temperature block, during the thermocycling.

2. The system of claim 1, wherein the system is operational to complete about 20 to 80 cycles of the thermocycling in at most about 10, 11, 12, 13, 14, 15, 16, 17, 18, 19 or 20 minutes.

3. The system of any one of the preceding claims, wherein during the thermocycling, the system is operational to transfer the one or more samples between the first temperature block and the second temperature block from about 10 to about 60 times per reaction.

4. The system of any one of the preceding claims, wherein the microplate comprises about 48, about 96, about 384 or about 1536 individual samples.

5. The system of any one of the preceding claims, wherein the first side of the microplate comprises an array of wells.

6. The system of claim 5, wherein the array conforms to a 2:3 ratio of wells along a length of the array to wells along an adjacent length of the array.

7. The system of any one of the preceding claims, further comprising one or more additional temperature blocks.

8. The system of any one of the preceding claims, wherein the system comprises a heatable lid, further wherein the system is configured to provide a force of about 10 to 300 Newtons to press the heatable lid against the microplate during thermocycling.

9. The system of any one of the preceding claims, wherein the metallic material is aluminum.

10. The system of any one of the preceding claims, wherein the metallic material is coated with polypropylene.

11. The system of any one of the preceding claims, wherein the denaturing temperature and/or the extension temperature is not achieved using direct resistive heating.

12. The system of any one of the preceding claims, further comprising a liquid handling or autopipette platform.

13. The system of any one of the preceding claims, wherein the conveyor comprises a robotic arm.

14. The system of any one of the preceding claims, wherein the sensing device is positioned between the first temperature block and the second temperature block, or above the first temperature block or the second temperature block, and determines a fluorescence response from the one or more samples.

15. The system of any one of the preceding claims, wherein the one or more barcodes are disposed on the first side.

16. The system of any one of the preceding claims, wherein the one or more barcodes are disposed on the second side.

17. The system of any one of the preceding claims, wherein one or more samples comprise nucleic acid samples.

18. The system of claim 17, wherein the one or more samples comprise deoxyribonucleic acid (DNA) samples.

19. The system of claim 14, wherein the fluorescence response comprises ultra-rapid fluorimetry measurements.

20. The system of any one of the preceding claims, wherein the microplate comprises alignment features for locating of the microplate for cycling the heating of the one or more samples.

21. The system of any one of the preceding claims, wherein the first temperature block provides the denaturing temperature for about 1 to 10 seconds and the second temperature block provides the extension temperature for about 1 to 30 seconds.

22. The system of any one of the preceding claims, wherein the denaturing temperature is between about 90° C. and 100° C.

23. The system of any one of the preceding claims, wherein the extension temperature is between about 50° C. and 65° C.

24. The system of any one of the preceding claims, wherein a transit time between the first temperature block and the second temperature block is between one and five seconds.

25. The system of any one of claims 14 or 19, wherein the fluorescence response is recorded on a transition between the second temperature block and the first temperature block.

26. The system of any one of claims 14, 19, or 25, wherein the sensing device includes one or more light-emitting diodes (LEDs) configured to measure the fluorescence response.

27. The system of any one of claims 14, 19, 25, or 26, wherein the fluorescence response is collected at a common temperature between about 50° C. and 65° C.

28. The system of any one of the preceding claims, wherein the microplate is supported by a carriage.

29. The system of any of one of the preceding claims, wherein the conveyor comprises rails.

30. The system of claim 29, wherein the microplate is driven by a mechanical actuator.

31. A system, comprising:
(a) a microplate for containing one or more samples during thermocycling, which microplate comprises a first side and a second side, which first side comprises a metallic material, wherein the microplate comprises one or more barcodes disposed on the first side or the second side;
(b) a first temperature block configured to receive the microplate and/or provide a denaturing temperature to the one or more samples contained in the microplate, during the thermocycling;
(c) a second temperature block configured to receive the microplate and/or provide an extension temperature to the one or more samples contained in the microplate, during the thermocycling;
(d) a sensing device positioned between the first temperature block and the second temperature block configured to determine a fluorescence response from the one or more samples;
(e) a conveyor configured to move the microplate between the first temperature block, the sensing device, and the second temperature block, so that the sensing device determines the fluorescence response from the one or more samples when the microplate moves between the second temperature block and the first temperature block, during the thermocycling.

32. The system of claim 31, wherein about 20 to 80 cycles of the providing the denaturing temperature and the providing the extension temperature are completed in at most about 10, 11, 12, 13, 14, 15, 16, 17, 18, 19, or 20 minutes.

33. The system of any one of claims 31 or 32, wherein during the thermocycling, the system is operational to transfer the one or more samples between the first temperature block and the second temperature block from about 10 to about 60 times per reaction.

34. The system of any one of claims 31 to 33, wherein the microplate comprises about 48, about 96, about 384 or about 1536 individual samples.

35. The system of any one of claims 31 to 34, wherein the first side of the microplate comprises an array of wells.

36. The system of any one of claims 31 to 35, wherein the array conforms to a 2:3 ratio of wells along a length of the array to wells along an adjacent length of the array.

37. The system of any one of claims 31 to 36, further comprising one or more additional temperature blocks.

38. The system of any one of claims 31 to 37, wherein the system comprises a heatable lid, further wherein the system is configured to provide a force of about 10 to 300 Newtons to press the heatable lid against the microplate during thermocycling.

39. The system of any one of claims 31 to 38, wherein the metallic material is aluminum.

40. The system of any one of claims 31 to 39, wherein the metallic material is coated with polypropylene.

41. The system of any one of claims 31 to 40, wherein the denaturing temperature or the extension temperature is not performed using direct resistive heating.

42. The system of any one of claims 31 to 41, further comprising a liquid handling or autopipette platform.

43. The system of any one of claims 31 to 42, wherein the conveyor comprises a robotic arm.

44. The system of any one of claims 31 to 43, wherein the sensing device is positioned between the first temperature block and the second temperature block, or above the first temperature block or the second temperature block, and determines a fluorescence response from the one or more samples.

45. The system of any one of claims 31 to 44, wherein the one or more barcodes are disposed on the first side.

46. The system of any one of claims 31 to 45, wherein the one or more barcodes are disposed on the second side.

47. The system of any one of claims 31 to 46, wherein one or more samples comprise nucleic acid samples.

48. The system of claim 47, wherein the one or more samples comprise deoxyribonucleic acid (DNA) samples.

49. The system of any one of claims 31 to 48, wherein the fluorescence response comprises ultra-rapid fluorimetry measurements.

50. The system of any one of claims 31 to 49, wherein the microplate comprises alignment features for locating of the microplate for cycling the heating of the one or more samples.

51. The system of any one of claims 31 to 50, wherein the first temperature block provides the denaturing temperature for about 1 to 10 seconds and the second temperature block provides the extension temperature for about 1 to 30 seconds.

52. The system of any one of claims 31 to 51, wherein the denaturing temperature is between about 90° C. and 100° C.

53. The system of any one of claims 31 to 52, wherein the extension temperature is between about 50° C. and 65° C.

54. The system of any one of claims 31 to 53, wherein a transit time between the first temperature block and the second temperature block is between one and five seconds.

55. The system of any one of claims 31 to 54, wherein the fluorescence response is recorded on a transition between the second temperature block and the first temperature block.

56. The system of any one of claims 31 to 55, wherein the sensing device includes one or more light-emitting diodes (LEDs) configured to measure the fluorescence response.

57. The system of any one of claims 31 to 56, wherein the fluorescence response is collected at a common temperature between 50° C. and 65° C.

58. The system of any one of claims 31 to 57, wherein the microplate is supported by a carriage.

59. The system of any of claims 31 to 58, wherein the conveyor comprises rails.

60. The system of claim 59, wherein the microplate is driven by a mechanical actuator.

61. A method for heating one or more samples during thermocycling, comprising:
(a) identifying the one or more samples;
(b) providing a denaturing temperature to the one or more samples at a first temperature zone during the thermocycling;
(c) providing an extension temperature to the one or more samples at a second temperature zone during the thermocycling; and
(d) moving the microplate between the first temperature zone and the second temperature zone.

62. The method of claim 61, wherein about 20 to 80 cycles of the providing the denaturing temperature and the providing the extension temperature are completed in at most about 10, 11, 12, 13, 14, 15, 16, 17, 18, 19, or 20 minutes.

63. The method of any one of claims 61 to 62, wherein during the thermocycling, the system is operational to transfer the one or more samples between the first temperature zone and the second temperature zone from about 10 to about 60 times per reaction.

64. The method of any one of claims 61 to 63, wherein the one or more samples comprise about 48, about 96, about 384 or about 1536 individual samples.

65. The method of any one of claims 61 to 64, wherein the one or more samples comprise an array of samples.

66. The method of claim 65, wherein the array of samples conforms to a 2:3 ratio of samples along a length of the array to samples along an adjacent length of the array.

67. The method of any one of claims 61 to 66, further comprising moving the one or more samples to additional temperature zones.

68. The method of any one of claims 61 to 67, wherein providing the extension temperature or the denaturing temperature to the one or more samples comprises exerting a force of about 10 to 300 Newtons of upward force on the one or more samples.

69. The method of any one of claims 61 to 68, further comprising determining a fluorescence response from the one or more samples when they are between the first temperature zone and the second temperature zone.

70. The method of claim 69, wherein the fluorescence response comprises ultra-rapid fluorimetry measurements.

71. The method of any one of claims 61 to 70, further including aligning the one or more samples prior to (b) and (c).

72. The method of any one of claims 61 to 71, wherein the denaturing temperature is provided for about 1 to 2 seconds and the extension temperature is provided for about 4 to 10 seconds.

73. The method of any one of claims 61 to 72, wherein the denaturing temperature is between about 92° C. and 97° C. and the extension temperature is between about 52° C. and 57° C.

74. The method of any one of claims 61 to 73, wherein a transit time between the first temperature zone and the second temperature zone is about 1 to 2 seconds.

75. The method of any one of claims 69 or 70, wherein the fluorescence response is recorded on a transition between the second temperature zone and the first temperature zone.

76. The method of any one of claims 69, 70, or 75, wherein the fluorescence response is collected at a temperature between about 50° C. and 65° C.

77. The method of claim 68, further comprising exerting a downward force on the one or more samples.

78. The method of claim 69, wherein determining a fluorescence response comprises illuminating the one or more samples with a controlled wavelength of light.

79. The method of any one of claims 61 to 78, wherein providing the denaturing temperature and/or the extension temperature to the one or more samples comprises thermal conduction via contact.

80. The method of any one of claims 61 to 79, wherein providing the extension temperature and/or the denaturing temperature comprises transferring heat to the samples.

81. The method of any one of claims 61 to 80, wherein providing the extension temperature and/or the denaturing temperature comprises transferring heat from the samples.

82. The system of any one of claims 1 or 31, wherein the sensing device is a camera.

83. The system of any one of claims 1, 31, or 82, further comprising (g) a glass lid disposed over the one or more samples.

84. The system of any one of claims 1, 31, 82, or 83, wherein the glass lid has a coating comprising indium tin oxide (ITO).

85. The system of any one of claims 1, 31, or 82 to 84, wherein the camera is further configured to detect the fluorescence response by simultaneously capturing images of all of the one or more samples.

86. A method for heating one or more samples during thermocycling, comprising:
(a) providing a denaturing temperature to the one or more samples at a first temperature zone during the thermocycling;
(b) providing an extension temperature to the one or more samples at a second temperature zone during the thermocycling;
(c) while repeatedly moving the one or more samples between the second temperature zone, determining a fluorescence response from the one or more samples when they are between the second temperature zone and the first temperature zone.

87. The method of claim 86, wherein about 20 to 80 cycles of the providing the denaturing temperature and the providing the extension temperature are completed in not more than about 10 to 20 minutes.

88. The method of any one of claims 86 to 87, wherein the one or more samples are transferred between the first temperature zone and the second temperature zone between about 10 and 60 times.

89. The method of any one of claims 86 to 88, wherein the one or more samples comprise about 48, about 96, about 384 or about 1536 individual samples.

90. The method of any one of claims 86 to 89, wherein the one or more samples comprise an array of samples.

91. The method of claim 90, wherein the array of samples conforms to a 2:3 ratio of samples along a length of the array to samples along an adjacent length of the array.

92. The method of any one of claims 86 to 91, further comprising moving the one or more samples between additional temperature zones.

93. The method of any one of claims 86 to 92, wherein providing the extension temperature or the denaturing temperature to the one or more samples includes exerting a force of about 10 to 300 newtons of upward force to the samples.

94. The method of any one of claims 86 to 93, wherein the fluorescence response comprises ultra-rapid fluorimetry measurements.

95. The method of any one of claims 86 to 94, further including aligning the one or more samples prior to (b) and (c).

96. The method of any one of claims 86 to 95, wherein the denaturing temperature is provided for about 1 to 2 seconds and the extension temperature is provided for about 4 to 10 seconds.

97. The method of any one of claims 86 to 96, wherein the denaturing temperature is between 92° C. and 97° C. and the extension temperature is between about 52° C. and 57° C.

98. The method of any one of claims 86 to 97, wherein a transit time between the first temperature zone and the second temperature zone is about one to five seconds.

99. The method of any one of claims 86 to 98, wherein the fluorescence response is recorded on a transition between the second temperature zone and the first temperature zone.

100. The method of any one of claims 86 to 99, wherein the fluorescence response is collected at a temperature between about 50° C. and 65° C.

101. The method of claim 93, further comprising exerting a downward force on the one or more samples.

102. The method of any of claims 86 to 101, wherein determining the fluorescence response comprises illuminating the one or more samples with a controlled wavelength of light.

103. The method of any of claims 86 to 102, wherein providing the denaturing temperature and/or the extension temperature to the one or more samples comprises thermal conduction via contact.

104. The method of any of claims 86 to 103, wherein providing the extension temperature and/or the denaturing temperature comprises transferring heat to the samples.

105. The method of claim 86 to 104, wherein providing the extension temperature and/or the denaturing temperature comprises transferring heat from the samples.

106. A system, comprising:
(a) a microplate for containing one or more samples during thermocycling, which microplate comprises a first side and a second side, which first side comprises a metallic material, wherein the microplate comprises one or more barcodes disposed on the first side or the second side;
(b) a barcode reader for reading the one or more barcodes;
(c) a first temperature block configured to receive the microplate and provide a denaturing temperature to the one or more samples contained in the microplate, during the thermocycling;
(d) a second temperature block configured to receive the microplate and provide an extension temperature to the one or more samples contained in the microplate, during the thermocycling; and
(e) a conveyor configured to move the microplate between a sensing device, the first temperature block, and the second temperature block, during the thermocycling.

107. The system of claim 106, wherein the system is operational to complete about 20 to 80 cycles of the thermocycling in at most about 10, 11, 12, 13, 14, 15, 16, 17, 18, 19 or 20 minutes.

108. The system of any one of claims 106 to 107, wherein during the thermocycling, the system is operational to transfer the one or more samples between the first temperature block and the second temperature block from about 10 to about 60 times per reaction..

109. The system of any one of claims 106 to 108, wherein the microplate comprises about 48, about 96, about 384 or about 1536 individual samples.

110. The system of any one of claims 106 to 109, wherein the first side of the microplate comprises an array of wells.

111. The system of claim 110, wherein the array conforms to a 2:3 ratio of wells along a length of the array to wells along an adjacent length of the array.

112. The system of any one of claims 106 to 111, further comprising one or more additional temperature blocks.

113. The system of any one of claims 106 to 112, wherein the system comprises a heatable lid, further wherein the system is configured to provide a force of about 10 to 300 Newtons to press the heatable lid against the microplate during thermocycling.

114. The system of any one of claims 106 to 113, wherein the metallic material is aluminum.

115. The system of any one of claims 106 to 114, wherein the metallic material is coated with polypropylene.

116. The system of any one of claims 106 to 115, wherein the denaturing temperature and/or the extension temperature is not achieved using direct resistive heating.

117. The system of any one of claims 106 to 116, further comprising a liquid handling or autopipette platform.

118. The system of any one of claims 106 to 117, wherein the conveyor comprises a robotic arm.

119. The system of any one of claims 106 to 118, wherein the sensing device is positioned between the first temperature block and the second temperature block, or above the first temperature block or the second temperature block, and determines a fluorescence response from the one or more samples.

120. The system of any one of claims 106 to 119, wherein the one or more barcodes are disposed on the first side.

121. The system of any one of claims 106 to 120, wherein the one or more barcodes are disposed on the second side.

122. The system of any one of claims 106 to 121, wherein one or more samples comprise nucleic acid samples.

123. The system of claim 122, wherein the one or more samples comprise deoxyribonucleic acid (DNA) samples.

124. The system of claim 119, wherein the fluorescence response comprises ultra-rapid fluorimetry measurements.

125. The system of any one of claims 106 to 124, wherein the microplate comprises alignment features for locating of the microplate for cycling the heating of the one or more samples.

126. The system of any one of claims 106 to 125, wherein the first temperature block provides the denaturing temperature for about 1 to 10 seconds and the second temperature block provides the extension temperature for about 1 to 30 seconds.

127. The system of any one of claims 106 to 126, wherein the denaturing temperature is between about 90° C. and 100° C.

128. The system of any one of claims 106 to 127, wherein the extension temperature is between about 50° C. and 65° C.

129. The system of any one of claims 106 to 128, wherein a transit time between the first temperature block and the second temperature block is between one and five seconds.

130. The system of any one of claims 119 or 124, wherein the fluorescence response is recorded on a transition between the second temperature block and the first temperature block.

131. The system of any one of claims 119, 124, or 130, wherein the sensing device includes one or more light-emitting diodes (LEDs) configured to measure the fluorescence response.

132. The system of any one of claims 119, 124, 130, or 131, wherein the fluorescence response is collected at a common temperature between about 50° C. and 65° C.

133. The system of any one of claims 106 to 132, wherein the microplate is supported by a carriage.

134. The system of any one of claims 106 to 133, wherein the conveyor comprises rails.

135. The system of any one of claims 106 to 134, wherein the microplate is driven by a mechanical actuator.

136. A system, comprising:
(a) a microplate for containing one or more samples during thermocycling, which microplate comprises a first side and a second side, which first side comprises a metallic material, wherein the microplate comprises one or more barcodes disposed on the first side or the second side;
(b) a first temperature block configured to receive the microplate and provide a denaturing temperature to the one or more samples contained in the microplate, during the thermocycling;
(c) a second temperature block configured to receive the microplate and provide an extension temperature to the one or more samples contained in the microplate, during the thermocycling;
(d) a sensing device positioned between the first temperature block and the second temperature block configured to determine a fluorescence response from the one or more samples;
(e) a conveyor configured to move the microplate between the first temperature block, the sensing device, and the second temperature block, so that the sensing device determines the fluorescence response from the one or more samples when the microplate moves between the second temperature block and the first temperature block, during the thermocycling.

137. The system of claim 136, wherein the system is operational to complete about 20 to 80 cycles of the thermocycling in at most about 10, 11, 12, 13, 14, 15, 16, 17, 18, 19 or 20 minutes.

138. The system of any one of claims 136 to 137, wherein during the thermocycling, the system is operational to transfer the one or more samples between the first temperature block and the second temperature block from about 10 to about 60 times per reaction.

139. The system of any one of claims 136 to 138, wherein the microplate comprises about 48, about 96, about 384 or about 1536 individual samples.

140. The system of any one of claims 136 to 139, wherein the first side of the microplate comprises an array of wells.

141. The system of any one of claims 136 to 140, wherein the array conforms to a 2:3 ratio of wells along a length of the array to wells along an adjacent length of the array.

142. The system of any one of claims 136 to 141, further comprising one or more additional temperature blocks.

143. The system of any one of claims 136 to 142, wherein the system comprises a heatable lid, further wherein the system is configured to provide a force of about 10 to 300 Newtons to press the heatable lid against the microplate during thermocycling.

144. The system of any one of claims 136 to 143, wherein the metallic material is aluminum.

145. The system of any one of claims 136 to 144, wherein the metallic material is coated with polypropylene.

146. The system of any one of claims 136 to 145, wherein the denaturing temperature and/or the extension temperature is not achieved using direct resistive heating.

147. The system of any one of claims 136 to 146, further comprising a liquid handling or autopipette platform.

148. The system of any one of claims 136 to 147, wherein the conveyor comprises a robotic arm.

149. The system of any one of claims 136 to 148, wherein the one or more barcodes are disposed on the first side.

150. The system of any one of claims 136 to 149, wherein the one or more barcodes are disposed on the second side.

151. The system of any one of claims 136 to 150, wherein one or more samples comprise nucleic acid samples.

152. The system of any one of claims 136 to 151, wherein the one or more samples comprise deoxyribonucleic acid (DNA) samples.

153. The system of any one of claims 136 to 152, wherein the fluorescence response comprises ultra-rapid fluorimetry measurements.

154. The system of any one of claims 136 to 153, wherein the microplate comprises alignment features for locating of the microplate for cycling the heating of the one or more samples.

155. The system of any one of claims 136 to 154, wherein the first temperature block provides the denaturing temperature for about 1 to 10 seconds and the second temperature block provides the extension temperature for about 1 to 30 seconds.

156. The system of any one of claims 136 to 155, wherein the denaturing temperature is between about 90° C. and 100° C.

157. The system of any one of claims 136 to 156, wherein the extension temperature is between about 50° C. and 65° C.

158. The system of any one of claims 136 to 157, wherein a transit time between the first temperature block and the second temperature block is between one and five seconds.

159. The system of any one of claims 136 to 158, wherein the fluorescence response is recorded on a transition between the second temperature block and the first temperature block.

160. The system of any one of claims 136 to 159, wherein the sensing device includes one or more light-emitting diodes (LEDs) configured to measure the fluorescence response.

161. The system of any one of claims 136 to 160, wherein the fluorescence response is collected at a common temperature between about 50° C. and 65° C.

162. The system of any one of claims 136 to 161, wherein the microplate is supported by a carriage.

163. The system of any one of claims 136 to 162, wherein the conveyor comprises rails.

164. The system of any one of claims 136 to 163, wherein the microplate is driven by a mechanical actuator.

165. A thermocycler system, comprising:
(a) a first temperature block configured to receive a microplate containing one or more samples and/or provide a denaturing temperature to the one or more samples contained in the received microplate, during thermocycling of the contained samples;
(b) a second temperature block configured to receive the microplate and/or provide an extension temperature to the one or more samples contained in the microplate, during the thermocycling;
(c) a barcode reader for reading one or more barcodes disposed on the microplate; and
(d) a conveyor configured to move the microplate between a sensing device, the first temperature block, and the second temperature block, during the thermocycling.

166. The system of claim 165, wherein the system is operational to complete about 20 to 80 cycles of the thermocycling in at most about 10, 11, 12, 13, 14, 15, 16, 17, 18, 19 or 20 minutes.

167. The system of any one of claims 165 to 166, wherein during the thermocycling, the system is operational to transfer the one or more samples between the first temperature block and the second temperature block from about 10 to about 60 times per reaction.

168. The system of any one of claims 165 to 167, wherein the microplate comprises about 48, about 96, about 384 or about 1536 individual samples.

169. The system of any one of 165 to 168, wherein the microplate comprises an array of wells.

170. The system of claim 169, wherein the array conforms to a 2:3 ratio of wells along a length of the array to wells along an adjacent length of the array.

171. The system of any one of claims 165 to 170, further comprising one or more additional temperature blocks.

172. The system of any one of claims 165 to 171, wherein the system comprises a heatable lid, further wherein the system is configured to provide a force of about 10 to 300 Newtons to press the heatable lid against the microplate during thermocycling.

173. The system of any one of claims 165 to 172, wherein the microplate comprises a first side, which first side comprises a metallic material, wherein the metallic material is aluminum.

174. The system of claim 173, wherein the metallic material is coated with polypropylene.

175. The system of any one of claims 165 to 174, wherein the denaturing temperature and/or the extension temperature is not achieved using direct resistive heating.

176. The system of any of claims 165 to 175, further comprising a liquid handling or autopipette platform.

177. The system of any one of claims 165 to 176, wherein the conveyor comprises a robotic arm.

178. The system of claim 165, wherein the sensing device is positioned between the first temperature block and the second temperature block, or above the first temperature block or the second temperature block, and determines a fluorescence response from the one or more samples.

179. The system of any one of claims 165 to 178, wherein the one or more barcodes are disposed on the first side.

180. The system of any one of claims 165 to 179, wherein the one or more barcodes are disposed on the second side.

181. The system of any one of claims 165 to 180, wherein one or more samples comprise nucleic acid samples.

182. The system of claim 181, wherein the one or more samples comprise deoxyribonucleic acid (DNA) samples.

183. The system of claim 178, wherein the fluorescence response comprises ultra-rapid fluorimetry measurements.

184. The system of any one of claims 165 to 183, wherein the microplate comprises alignment features for locating of the microplate for cycling the heating of the one or more samples.

185. The system of any one of claims 165 to 184, wherein the first temperature block provides the denaturing temperature for about 1 to 10 seconds and the second temperature block provides the extension temperature for about 1 to 30 seconds.

186. The system of any one of claims 165 to 185, wherein the denaturing temperature is between about 90° C. and 100° C.

187. The system of any one of claims 165 to 186, wherein the extension temperature is between about 50° C. and 65° C.

188. The system of any one of claims 165 to 187, wherein a transit time between the first temperature block and the second temperature block is between one and five seconds.

189. The system of any one of claims 178 or 183, wherein the fluorescence response is recorded on a transition between the second temperature block and the first temperature block.

190. The system of any one of claims 178, 183, or 189, wherein the sensing device includes one or more light-emitting diodes (LEDs) configured to measure the fluorescence response.

191. The system of any one of claims 178, 183, 189, or 190, wherein the fluorescence response is collected at a common temperature between about 50° C. and 65° C.

192. The system of any one of claims 165 to 191, wherein the microplate is supported by a carriage.

193. The system of any one of claims 165 to 192, wherein the conveyor comprises rails.

194. The system of any one of claims 165 to 193, wherein the microplate is driven by a mechanical actuator.
